(19) United States
(12) Patent Application Publication
(10) Pub. No.: US 2009/0218416 A1
(43) Pub. Date: Sep. 3, 2009

(54) Water Discharger

(76) Inventors: Takahiro Ohashi, Fukuoka-ken (JP); Yasuo Hamada, Fukuoka-ken (JP)

Correspondence Address: CARRIER BLACKMAN AND ASSOCIATES, 24101 NOVI ROAD, SUITE 100, NOVI, MI, 48375, US

(21) Appl. No.: 11/922,627

(22) PCT Filed: Mar. 6, 2006
(86) PCT No.: PCT/JP2006/304298

§ 371 Date: Oct. 20, 2008

(51) Int. Cl. B05B 3/16

(52) U.S. Cl. 239/242

(57) ABSTRACT

A water discharger according to the invention comprises a housing having a columnar space inside, a core having a core inner channel inside allowed to move in the space while dividing the columnar space into a first and a second pressure chamber, a water discharge tubular body having a water discharge channel communicating with the core inner channel and reaching the outside of the housing, a first water inlet port for introducing fluid to the first pressure chamber, a second water inlet port for introducing fluid to the second pressure chamber, a first introducing port for introducing fluid from the first pressure chamber to the core inner channel, a second introducing port for introducing fluid from the second pressure chamber to the core inner channel, a valve body for changing the opening of the first and the second introducing port, and control means for inverting the size relation of the opening of the first and the second introducing port when the core reverses its moving direction. This enables repetitive linear action or rotary action using hydraulic power with a compact and simple structure.

### TECHNICAL FIELD

This invention relates to a water discharger, and more particularly to a water discharger capable of automatic reciprocating action for repetitively changing the water discharge position and water discharge direction of a shower nozzle, sprinkler nozzle and the like.

### BACKGROUND ART

There are growing needs for shower systems and water discharge/spray systems intended for relaxation, beauty/health enhancement and the like. In an approach for these applications, for example, swirling flow or the like is used to modulate water flow at a relatively fast rate of several tens of hertz or more for enhancing massage effect and the like. On the other hand, the water discharge position and water discharge direction of a shower nozzle or the like can be repetitively changed at a relatively slow rate of several hertz or less, for example, to uniformly spray water onto a prescribed area of a human body for enhancing relaxation effect and the like.

Similar needs are also widely present in consumer appliances and in industry, agriculture, forestry, and other applications, where slow reciprocating action is needed for various purposes such as washing, rinsing, cooling, humidifying, preprocessing, and nourishing.

Electrically-operated means such as a motor or solenoid can also be used for reciprocating action. However, for installing such means into a system for discharging water in a bathroom or the like, it is necessary to ensure power supply and to take measures against electric shock and leakage and the like. There are also many problems to be solved with regard to cost and reliability.

In this respect, if reciprocating action can be achieved hydraulically, the need for electricity, lubricating oil and the like is eliminated, and improvement can be expected in many aspects such as initial cost, running cost, reliability, and maintainability.

A shower device capable of vertical reciprocating action is disclosed (Patent Document 1: JP 2-134119A), where a piston is combined with a four-way valve. In this shower device, a piston provided in a cylinder is moved vertically by hydraulic pressure, and a shower head is moved vertically through a wire. The vertical motion of the piston is switched by switching the water supply channel to the cylinder using the four-way valve.

### DISCLOSURE OF INVENTION

### Problems to be solved by the invention

However, in the case of this shower device, the cylinder and the four-way valve are provided as separate members, and the system is large and complex. Furthermore, there is room to improve that the long channel results in large pressure loss and decreases water discharge power.

This invention has been made in consideration of these problems. An object of the invention is to provide, on the basis of a new idea, a water discharger having a compact and simple structure and capable of repetitive linear action or rotary action using hydraulic power.

### Solution to the Problems

To achieve the above object, in an aspect of the invention, a water discharger is provided, which comprises a housing having a columnar space inside, a core having a core inner channel inside allowed to move in the space while dividing the columnar space into a first and a second pressure chamber, a water discharge tubular body having a water discharge channel communicating with the core inner channel and reaching the outside of the housing, a first water inlet port for introducing fluid to the first pressure chamber, a second water inlet port for introducing fluid to the second pressure chamber, a first introducing port for introducing fluid from the first pressure chamber to the core inner channel, a second introducing port for introducing fluid from the second pressure chamber to the core inner channel, a valve body for changing the opening of the first and the second introducing port, and control means for inverting the size relation of the opening of the first and the second introducing port when the core reverses its moving direction

According to the above configuration, the water discharge tubular body can be moved with the movement of the core. Thus a water discharger that hydraulically changes the water discharge position can be provided. Furthermore, by inverting the size relation of the opening of the first and the second introducing port, a reciprocating linear motion can be produced with a compact and simple configuration.

Moreover, the core may move toward the second pressure chamber when fluid is supplied to the first and second water inlet port with the first introducing port being closed and the second introducing port being opened, and the core may move toward the first pressure chamber when fluid is supplied to the first and second water inlet port with the second introducing port being closed and the first introducing port being opened. Then the pressure difference between the first and second pressure chamber can be produced more reliably and stably, and the core can be moved more reliably and stably.

Moreover, the moving direction of the core may be generally the same as the movable direction of the valve body. Then the motion of the core can be used to move the valve body, and a smooth reversal action can be achieved.

In another aspect of the invention, a water discharger is provided, which comprises a housing having a fan-shaped space inside, a core having a core inner channel inside allowed to oscillate in the space while dividing the fan-shaped space into a first and a second pressure chamber, a water discharge tubular body having a water discharge channel communicating with the core inner channel and reaching the outside of the housing, a first water inlet port for introducing fluid to the first pressure chamber, a second water inlet port for introducing fluid to the second pressure chamber, a first introducing port for introducing fluid from the first pressure chamber to the core inner channel, a second introducing port for introducing fluid from the second pressure chamber to the core inner channel, a valve body for changing the opening of the first and the second introducing port, and control means for inverting the size relation of the opening of the first and the second introducing port when the core reverses its oscillating direction.

According to the above configuration, the water discharge tubular body can be rotated with the oscillation of the core. Thus a water discharger that hydraulically changes the water discharge direction can be provided. Furthermore, by inverting the size relation of the opening of the first and the second introducing port, a reciprocating rotary motion can be produced with a compact and simple configuration.

Here, the core may oscillate toward the second pressure chamber when fluid is supplied to the first and second water inlet port with the first introducing port being closed and the second introducing port being opened, and the core may oscillate toward the first pressure chamber when fluid is supplied to the first and second water inlet port with the second introducing port being closed and the first introducing port being opened. Then the pressure difference between the first and second pressure chamber can be produced more reliably and stably, and the core can be oscillated more reliably and stably.

Moreover, the oscillating direction of the core may be generally the same as the movable direction of the valve body. Then the oscillation of the core can be used to move the valve body, and a smooth reversal action can be achieved.

Moreover, when the core reverses its oscillating direction, at least one of the valve body and the control means may abut against an inner wall of the housing, and the abutment of the inner wall may maintain a generally perpendicular relation to the movable direction of the valve body. Then the movement of the valve body can be facilitated depending on the oscillation of the core. Thus the reversal action can be made smooth and more reliable.

The control means can alternatively retain a first state where the opening of the second introducing port is larger than the opening of the first introducing port and a second state where the opening of the first introducing port is larger than the opening of the second introducing port. Then the openings of the first introducing port and the second introducing port are prevented from being left to be in a generally identical state, and thus the core can be prevented from remaining stopped.

In any of the aspects described above, the control means may comprises a slide bar for moving the valve body, the slide bar being movable with a longer stroke than the moving stroke of the valve body, and a leaf spring for biasing the slide bar to one of a first end and a second end of the stroke thereof. That is, a reliable and compact control means can be constructed from the leaf spring and the slide bar. Then the openings of the first introducing port and the second introducing port are prevented from being left to be in a generally identical state, and thus the core can be reliably prevented from stopping.

### BRIEF DESCRIPTION OF DRAWINGS

FIG. 1 is a schematic view illustrating the overall configuration of a water discharger in accordance with an embodiment of the invention.

FIG. 2 is a schematic view for describing the mechanism of the water discharger in accordance with an embodiment of the invention.

FIG. 3 is a schematic view for describing the mechanism of the water discharger in accordance with an embodiment of the invention.

FIG. 4 is a schematic view for describing the mechanism of the water discharger in accordance with an embodiment of the invention.

FIG. 5 is a schematic view for describing the mechanism of the water discharger in accordance with an embodiment of the invention.

FIG. 6 is a schematic view for describing the function and effect of providing an opening difference between introducing ports 32, 34.

FIG. 7 is a schematic view for describing the mechanism of controlling the reversal action of the core by a magnet.

FIG. 8 is a perspective view of a water discharger according to a first embodiment of the invention.

FIG. 9 is a perspective cutaway view of the water discharger of the first embodiment.

FIG. 10 is a cross section of the water discharger of the first embodiment.

FIG. 11 is a cross section along line 11-11 in FIG. 10.

FIG. 12 is a perspective view showing the valve body.

FIG. 13 is a schematic view showing the reciprocating action of the water discharger in the first embodiment.

FIG. 14 is a schematic view for describing the operation of the control means in the first embodiment.

FIG. 15 is a perspective view of a water discharger according to a second embodiment of the invention.

FIG. 16 is a perspective cutaway view of the water discharger of the second embodiment.

FIG. 17 is a vertical cross section of the water discharger of the second embodiment.

FIG. 18 is a cross section along line 18-18 in FIG. 17.

FIG. 19 is a schematic view showing the reciprocating action of the water discharger of the second embodiment.

FIG. 20 is a perspective view of a water discharger of a third embodiment of the invention.

FIG. 21 is a perspective cutaway view of the water discharger of the third embodiment.

FIG. 22 is a cross section of the water discharger of the third embodiment.

FIG. 23 is a cross section along line 23-23 in FIG. 9.

FIG. 24 is a perspective view showing the main valves and the slide bars.

FIG. 25 is a schematic view for describing the action of the water discharger of the third embodiment.

FIG. 26 is a schematic view showing the reciprocating action of the water discharger of the third embodiment.

FIG. 27 is a schematic view for describing the operation of the control means in the third embodiment.

FIG. 28 is a schematic cross section showing a variation of the water discharger of the third embodiment.

FIG. 29 is a perspective view of a water discharger according to a fourth embodiment of the invention.

FIG. 30 is a perspective cutaway view of the water discharger of the fourth embodiment.

FIG. 31 shows a perspective view and a cutaway view of the water discharger of the fourth embodiment as viewed from the bottom side.

FIG. 32 is a vertical cross section of the water discharger of the fourth embodiment.

FIG. 33 is a cross section along line 33-33 in FIG. 19.

FIG. 34 is a schematic view for describing the action of the water discharger of the fourth embodiment.

FIG. 35 is a schematic view for describing the abutment angle between slide bar 246, 248 and the inner wall of housing main body 202 in the fourth embodiment.

FIG. 36 is a schematic view showing a first example of the water discharger of the invention.

FIG. 37 is a schematic view showing a second example of the water discharger of the invention.

FIG. 38 is a schematic view showing a third example of the water discharger of the invention.

FIG. 39 is a schematic view showing a fourth example of the water discharger of the invention.

FIG. 40 is a schematic view showing a fifth example of the water discharger of the invention.

FIG. 41 is a schematic view showing a sixth example of the water discharger of the invention.

### DESCRIPTION OF REFERENCE NUMERALS

12, 14 water inlet port
16, 18 pressure chamber
core
32, 34 introducing port
42, 44 valve body
10, 100, 200, 300, 400 water discharger
housing
102, 202 housing main body
104, 203, 204 housing lid
112, 114, 212, 214 water inlet port
116, 118, 216, 218 pressure chamber
120, 220 core main body
122, 222 core lid
124, 224 core inner channel
126, 226, 227 seal
132, 134, 232, 234 introducing port
142, 144, 242, 244 main valve
146, 148, 246, 248 slide bar
coupling rod
160, 260 leaf spring
180, 280 water discharge tubular body
182, 282 water discharge channel
seal
352, 354 valve body
magnet
372, 374 magnet (ferromagnet)
452, 454 valve body
magnet
472, 474 magnet (ferromagnet)
water supply piping
800, 810 water discharge nozzle
shower nozzle
830, 840 water discharge nozzle
wall
base
horizontal plane
toilet bowl
toilet seat
toilet seat lid
body washer
solar cell panel
roof

### BEST MODE FOR CARRYING OUT THE INVENTION

Embodiment of the invention will now be described with reference to the drawings.

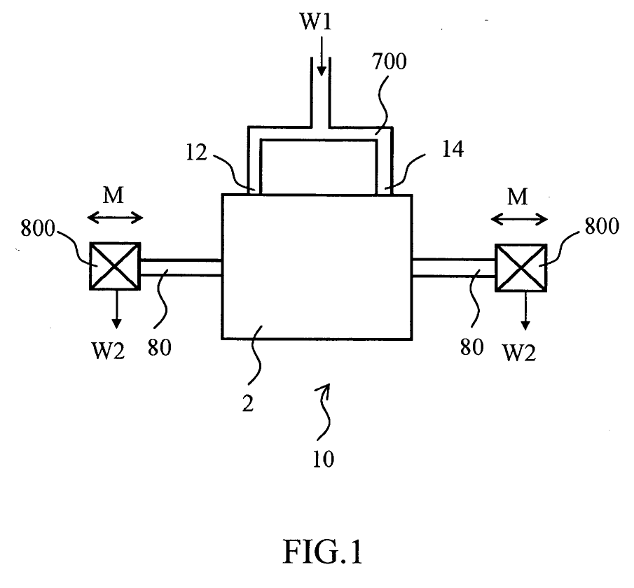

FIG. 1 is a schematic view illustrating the overall configuration of a water discharger of the invention.

More specifically, water discharger 10 of the invention has housing 2 and water discharge tubular body 80 protruding from housing 2. While FIG. 1 shows a water discharger with water discharge tubular body 80 protruding from both sides of housing 2, the invention is not limited thereto. As described later with reference to examples, water discharge tubular body 80 may be provided only on one side of housing 2. Inside water discharge tubular body 80 is provided water discharge channel 82, at the tip of which is coupled water discharge nozzle 800 such as a shower nozzle, and thereby achieving water discharge W2.

Housing 2 has two water inlet ports 12, 14. Water inlet ports 12, 14 are coupled in parallel. When fluid W1 such as cold or hot water is supplied to water inlet ports 12, 14 at nearly the same pressure, water discharge tubular body 80 discharges fluid W from water discharge nozzles 800 with reciprocating right and left as shown by arrow M. Thus, if housing 2 is fixed, the water discharger can be used to change the water discharge position repetitively. On the other hand, if water discharge nozzles 800 are fixed, housing 2 will be in repetitive motion. This motion can also be used for massage and the like, for example.

In addition, this invention allows not only reciprocating linear motion but also reciprocating rotary motion. This point will be described later in detail with reference to examples.

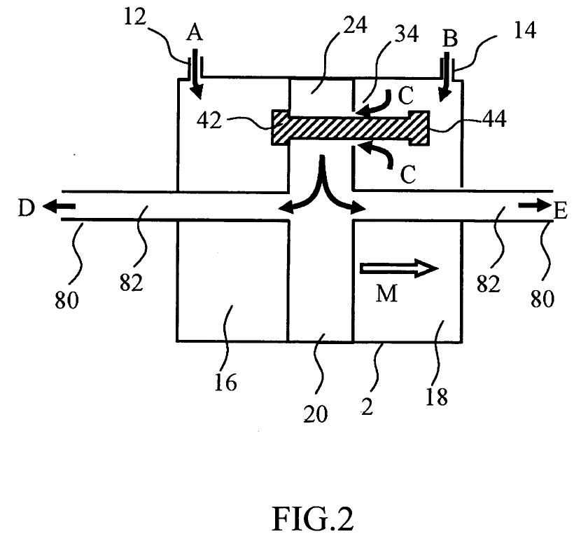

FIGS. 2 to 5 are schematic views for describing the mechanism of the water discharger of the invention. More specifically, the water discharger of the invention has core 20 movably provided in housing 2. The interior of housing 2 is divided by core 20 into two pressure chambers 16, 18. Core 20 has a hollow structure. The hollow space constitutes core inner channel 24 communicating with water discharge channel 82 provided in water discharge tubular body 80. Core inner channel 24 communicates with pressure chambers 16, 18 via introducing ports 32, 34, respectively.

Core 20 is provided with valve bodies 42, 44 for changing the opening of introducing ports 32, 34. Core 20 is also provided with a control means for controlling valve bodies 42, 44. The control means can produce an opening difference between introducing ports 32 and 34, thereby causing a difference in channel resistance between the right and left channel extending from the water inlet port to core inner channel 24. The resulting pressure difference between right and left pressure chamber 16, 18 can be used to move core 20. In the state shown in FIG. 2, the control means causes valve bodies 42, 44 to be biased to the right end, and introducing port 34 for fluid is opened on the right side of core 20. Therefore the fluid such as water supplied from water inlet port 14 flows from pressure chamber 18 into core inner channel 24 of core 20 along the path shown by arrow C, passes through water discharge channel 82 provided in water discharge tubular body 80, and flows out as shown by arrows D, E. On the other hand, because the fluid supplied from water inlet port 12 of the housing has no outflow path, the pressure in pressure chamber 16 becomes higher than the pressure in pressure chamber 18. As a result, core 20 moves in the direction of arrow M.

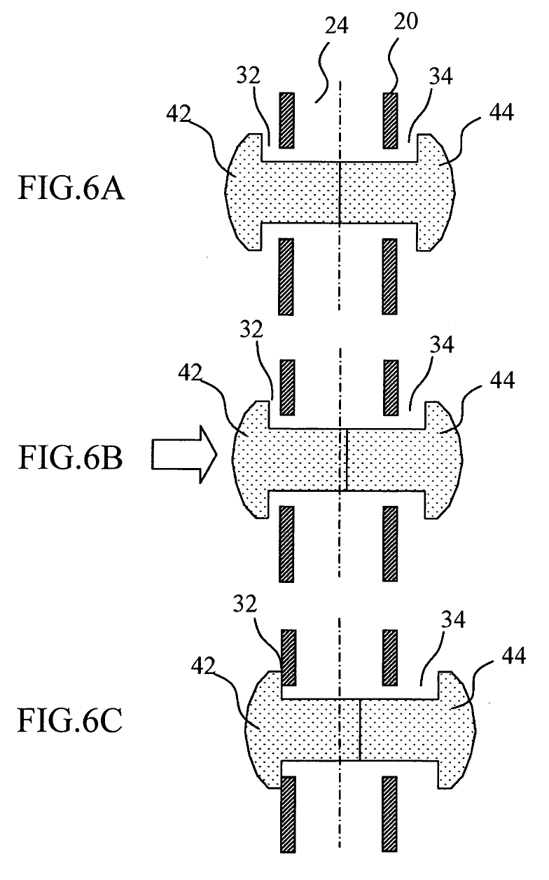

FIG. 6 is a schematic view for describing the function and effect of providing an opening difference between introducing ports 32, 34.

More specifically, as illustrated in FIG. 6(a), when valve bodies 42, 44 are in a neutral state and introducing ports 32, 34 have nearly the same opening, the channels through introducing ports 32, 34 also have nearly the same channel resistance and hence causes no pressure difference between the right and left side of core 20. Therefore core 20 does not move unless any external force acts thereon.

On the other hand, as illustrated in FIG. 6(b), when valve bodies 42, 44 deviate from the neutral state and an opening difference occurs between introducing port 32 and 34, a difference also occurs in channel resistance and causes a pressure difference between the right and left side of core 20.

Note that the “opening” of the introducing port used herein refers to a parameter determining the channel resistance for fluid flowing between the introducing port and the valve body. For example, in the state shown in FIG. 6(b), the channel resistance of the channel formed between introducing port 32 and valve body 42 is higher than the channel resistance of the channel formed between introducing port 34 and valve body 44. In this case, the opening of introducing port 32 is smaller than the opening of introducing port 34.

In the example shown in FIG. 6(b), because the opening of introducing port 34 is larger than the opening of introducing port 32, the channel through introducing port 32 has a higher channel resistance. As a result, the pressure on the left side of core 20 is higher than that on the right side. Consequently, forces due to the pressure difference act on core 20 and valve body 42, respectively.

Therefore, when the force applied to core 20 exceeds the sliding resistance, core 20 moves to the right side. On the other hand, valve body 42 is also movable relative to core 20. Thus, when the force applied to valve body 42 exceeds the sliding resistance of valve body 42, valve body 42 moves to the right side relative to core 20. If valve body 42 moves to the right side, the channel through introducing port 32 has an even higher channel resistance, which expands the pressure difference. That is, the forces applied to core 20 and valve 42 are increased, respectively, and the movement of core 20 and valve body 42 is promoted.

Ultimately, as shown in FIG. 6(c), introducing port 32 is fully closed. At this time, the left-right difference in channel resistance is maximized, and forces corresponding to the maximum pressure difference act on core 20 and valve body 42, respectively.

As described above, according to the invention, core 20 can be moved simply by providing an opening difference between introducing ports 32, 34 to produce a pressure difference required for the movement. Then the pressure difference is maximized by causing one of the introducing ports to be in the open state and the other to be in the closed state. This achieves the most reliable and stable force for movement.

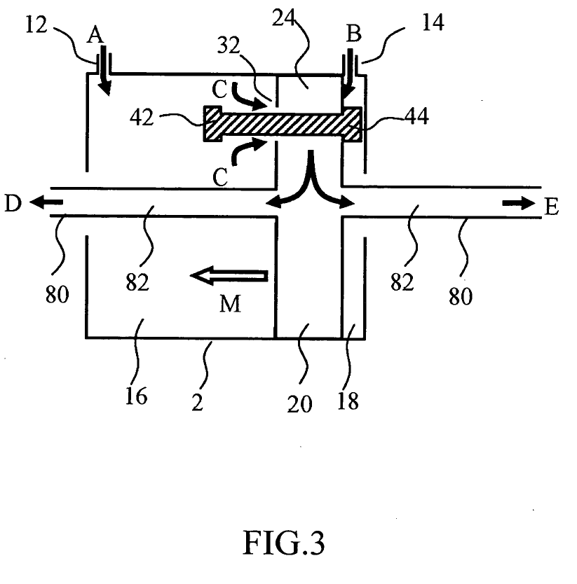

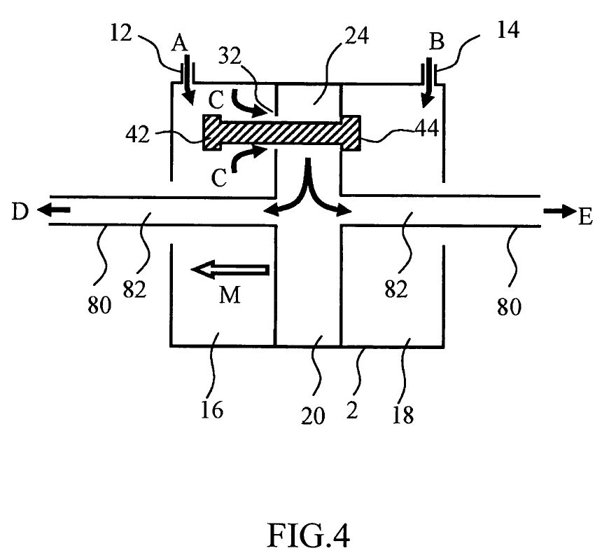

Returning again to FIG. 3, as shown in this figure, when core 20 moves in housing 2 to or near the right end of its moving stroke, valve bodies 42, 44 move to the left side by the control means. Then, introducing port 34 on the right side of core 20 is closed, and introducing port 32 on the left side is opened. In this state, fluid supplied from water inlet port 12 flows from pressure chamber 16 via introducing port 32 into core inner channel 24 of core 20 as shown by arrow C, and flows out of water discharge tubular body 80 as shown by arrows D, E. On the other hand, because the fluid supplied from water inlet port 14 has no outflow path, the pressure in pressure chamber 18 is increased. As a result, core 20 moves to the left as shown by arrow M in FIGS. 3 and 4.

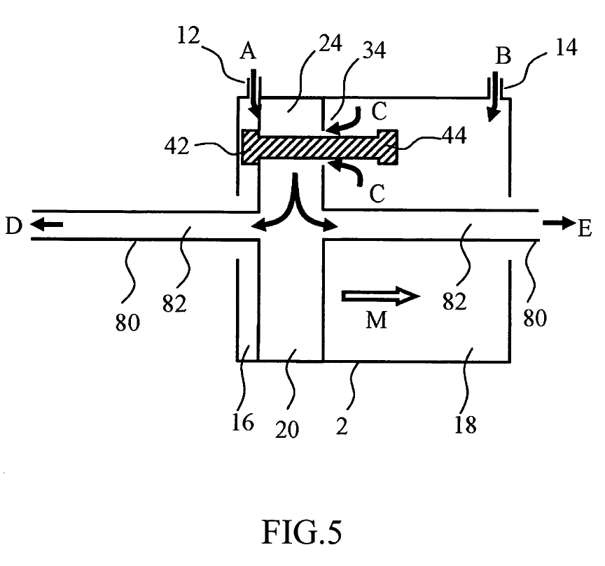

When core 20 continues to move to the left side and arrives at or near the left end of housing 2 as shown in FIG. 5, valve bodies 42, 44 move to the right side by the control means. Then, as described above with reference to FIG. 2, introducing port 32 on the left side of core 20 is closed, and introducing port 34 on the right side is opened. As a result, the pressure in pressure chamber 18 is decreased, the pressure in pressure chamber 16 is increased, and core 20 moves to the right side as shown by arrow M. Subsequently, by repeating the action described above with reference to FIGS. 2 to 5, core 20 continues to reciprocate in housing 2.

As described above, when core 20 is reversed in housing 2, valve bodies 42, 44 are controlled by the control means. Such control can be achieved by using a magnet, for example.

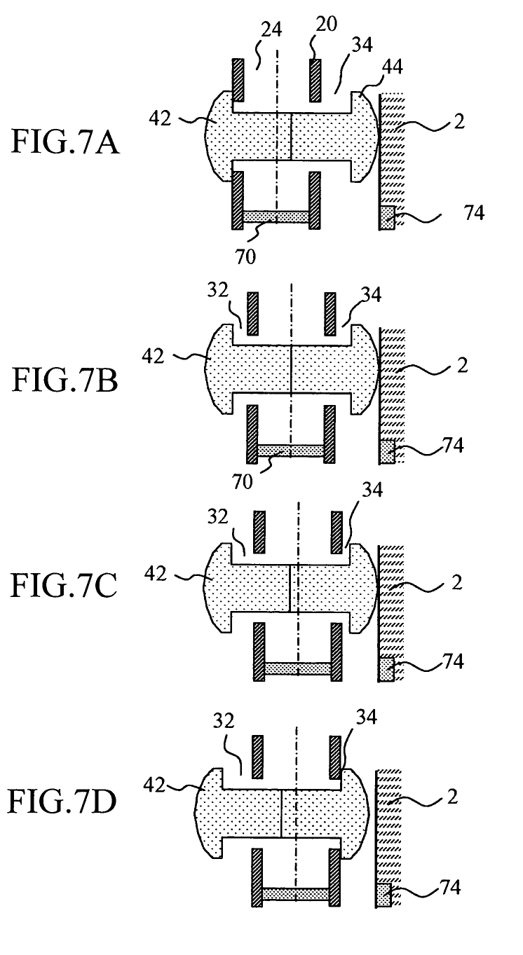

FIG. 7 is a schematic view for describing the mechanism of controlling the reversal action of the core by a magnet.

More specifically, FIG. 7(a) shows the situation where core 20 moves from the left side toward the right side and valve body 44 abuts against the inner wall of housing main body 2. In this example, core 20 has magnet 70, and housing 2 has magnet (or ferromagnet) 74. In the state of FIG. 7(a), because a force due to the pressure difference acts on core 20, core 20 moves further to the right side. That is, core 20 moves further to the right side while valve body 44 abuts against housing 2 and fixed relative to the moving direction.

Then the state eventually becomes as shown in FIG. 7(b). In this state, because introducing ports 32, 34 have nearly the same opening, no pressure difference occurs due to the difference in channel resistance. However, at this time, core 20 can be further pulled to the right side by the attractive force acting between magnet 70 and magnet 74.

Note here that, depending on the value of sliding resistance of core 20, core 20 may stop before reaching the state shown in FIG. 7(b). In such a case, i.e. the state between FIG. 7(a) and FIG. 7(b), it is desirable to pull core 20 by the attractive force acting between magnet 70 and magnet 74.

In the state shown in FIG. 7(b), when core 20 is pulled to the right side by the attractive force of the magnet, a state occurs as shown in FIG. 7(c) where the opening of introducing port 32 is larger than the opening of introducing port 34. Then a difference in channel resistance occurs between introducing ports 32 and 34 and causes a pressure difference. More specifically, the pressure on the right side of core 20 becomes higher, and core 20 begins to move to the left side. That is, core 20 can be reversed by inverting the size relation of the opening difference between introducing ports 32 and 34.

In addition, at this time, as described above with reference to FIG. 6, the pressure difference also acts on valve body 44, and a force is applied thereto in the direction of closing valve 44. As a result, as shown in FIG. 7(d), valve body 44 is completely closed, and the pressure on the right side of core 20 is increased to its maximum. That is, after core 20 is reversed, a maximum driving force toward the left side is produced.

As described above, if core 20 can be pulled to the state shown in FIG. 7(c) by the attractive force acting between magnet 70 and magnet 74, the size relation of the opening difference between introducing ports 32 and 34 can be inverted, and core 20 can be reversed. That is, core 20 can reciprocate linearly in housing 2.

Here, after the reversal, core 20 needs to move against the attractive force of the magnet. That is, it is desirable to adjust an appropriate balance between the force acting on core 20 due to the pressure difference and the attractive force produced by the magnet.

In the example shown in FIG. 7, the surface of valve bodies 42, 44 (the surface abutting against housing 2) protrudes in a curved configuration, which allows an interstice to occur even when the surface abuts against housing 2. Thus, by decreasing the area of abutment against housing 2, the pressure difference applied to the valve bodies can be effectively used to facilitate the reversal action of the valve body for inverting the size relation of the opening.

In the example shown in FIG. 7, the valve bodies 42, 44 abuts against the inner wall of housing 2 when core 20 is reversed. However, the invention is not limited thereto. For example, valve bodies 42, 44 can be provided with a magnet, the inner wall of housing 2 can also be provided with a magnet, and the repulsive force acting therebetween can be used to stop valve bodies 42, 44 relative to housing 2. That is, in this case, in the state corresponding to FIGS. 7(a) to 7(c), valve bodies 42, 44 does not abut against the inner wall of housing 2, but is located at a prescribed distance apart from the inner wall of housing 2 by the repulsive force of the magnets (not shown). Thus the core can be reversed in a noncontact manner.

As described above, core 20 can be moved simply by providing an opening difference between the introducing port 32 and 34 to produce a pressure difference required for the movement. Likewise, the moving direction of core 20 can be reversed simply by inverting the size relation of the opening of introducing ports 32, 34 using the control means. For example, the ratio of opening between introducing ports 32, 34 can be changed from 70:30 to 30:70 by the control means to achieve the reversal action. Furthermore, when the opening is changed from 100:0 to 0:100 by the control means, the most reliable and stable reversal action is achieved.

According to the invention, the core contained in housing 2 is provided with valve bodies 42, 44 and the control means. Core 20 can be reciprocated by supplying fluid into the pressure chambers on both sides thereof. Here, the moving direction of core 20 is made generally the same as the movable direction of valve bodies 42, 44 to interlock the moving action and the opening control action of core 20. Thus the reversal action of the valve bodies to invert the size relation of the opening of introducing ports 32, 34 for the reversal of core 20 is made reliable and easy, and the valve bodies and the control means are made simple and compact.

According to the invention, no mechanical power of electricity and the like is needed. A smooth reciprocating reversal motion is achieved simply using the pressure supplied by water (fluid), and there is no need to install electric power supply or to take measures against electric shock and leakage and the like. Furthermore, a smooth action is achieved without being affected by external disturbances such as electromagnetic noise. As a result, stable operation can be achieved in various environments such as in a bathroom, in the outdoor, or in various industrial fields.

Furthermore, in the water discharger of the invention, valve bodies 42, 44 and the control means accompany core 20. Therefore the need for an external four-way valve, for example is eliminated, and a smooth reciprocating reversal motion can be achieved by a simple configuration. This facilitates downsizing and simplifies the channel. Thus, advantageously, the pressure loss can be reduced, and a sufficient amount and pressure of water discharge can be ensured. Furthermore, because of the structure of incorporating valve bodies 42, 44 and the control means in housing 2, a smooth action resistant to external disturbances can be achieved. As a result, stable operation can be achieved in various environments such as in a bathroom, in the outdoor, or in various industrial fields.

Moreover, water supply can be implemented simply by coupling the lines branched from a common water supply source to two water inlet ports, achieving good workability.

Furthermore, because the fluid channel is formed inside the moving core and water discharge tubular body, the position and direction of water discharge can be reciprocated simply by coupling various water discharge nozzles at the tip of the water discharge tubular body, and no special connecting members are needed. This also allows good workability.

In the following, the water discharger of the invention will be described in more detail with reference to examples.

As a first embodiment of the invention, a water discharger having a control means including a magnet and a leaf spring in combination is described.

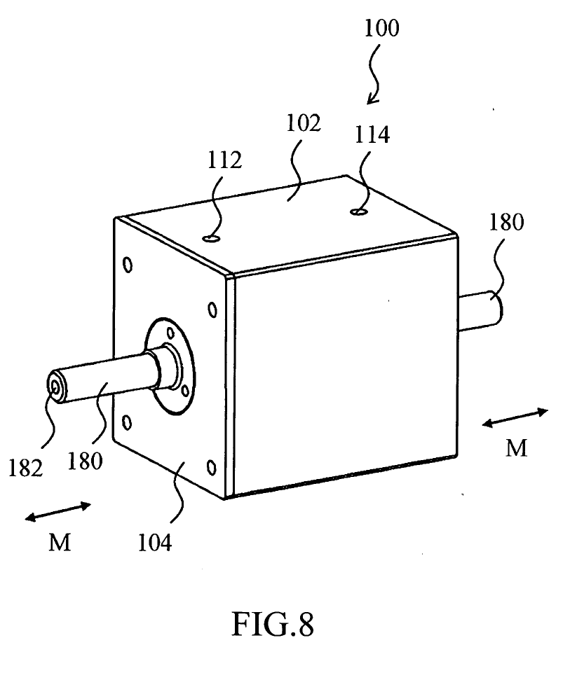

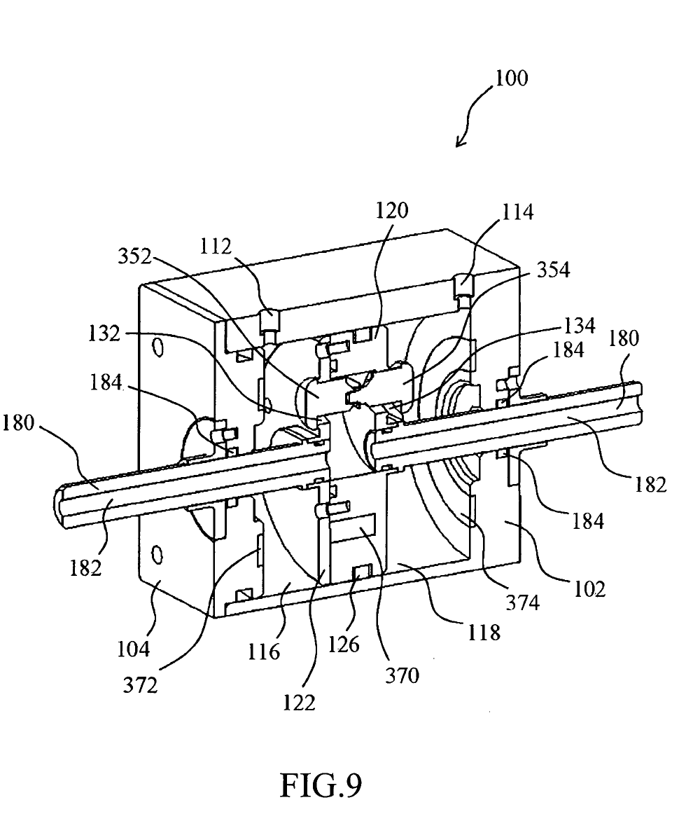

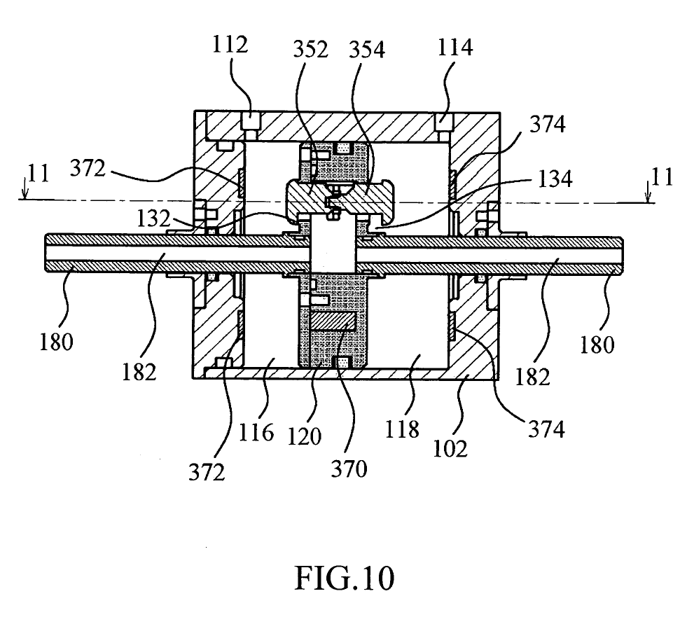

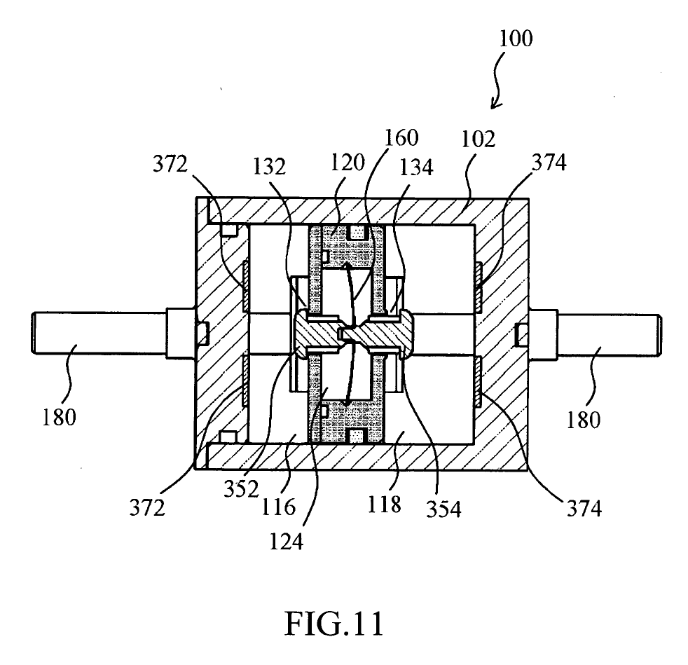

FIGS. 8 to 11 are schematic views showing the relevant part of a water discharger of the first embodiment of the invention. More specifically, FIG. 8 is a perspective view of the water discharger of this embodiment, FIG. 9 is a perspective cutaway view thereof, FIG. 10 is a cross section, and FIG. 11 is a cross section along line 11-11 in FIG. 10. Water discharger 100 of this embodiment has water discharge tubular body 180 that illustratively protrudes from both sides of the housing formed from housing main body 102 and housing lid 104. Water discharge tubular body 180 has a hollow structure having water discharge channel 182 inside and opened at the tip. Water discharge tubular body 180 does not necessarily need to be shaped as a circular cylinder, but various other examples may be contemplated including a rectangular cylinder and a flattened shape.

When fluid such as water is introduced into water inlet ports 112, 114 provided in housing main body 102, water discharge tubular body 180 protruding on either side reciprocates linearly in the direction of arrow M. Therefore a water discharger having a repetitively moving water discharge position can be constructed by providing a water discharge nozzle such as a shower nozzle at the tip of water discharge tubular body 180.

The internal structure is described. As shown in FIGS. 9 to 11, a core composed of core main body 120 and core lid 122 is movably contained in a cylinder space formed from housing main body 102 and housing lid 104. Core main body 120 and core lid 122 are each coupled to water discharge tubular body 180 protruding from both sides of the housing, and move like a piston, dividing the interior of the housing into first pressure chamber 116 and second pressure chamber 118. Fluid such as water is introduced from water inlet ports 112, 114 into pressure chambers 116, 118, respectively. The sliding portion between core main body 120 and the inner wall of housing main body 102 is provided with seal 126 for facilitating sliding while maintaining liquid tightness. The sliding portion between tubular body 180 and housing main body 102 (housing lid 104) is also provided with seal 184 for the same purpose. Seals 126, 184 can be made of such materials as Teflon®, NBR (nitrile rubber), EPDM (ethylene-propylene rubber), and POM (polyacetal). “Liquid tightness” used herein can be satisfied by ensuring the condition sufficient for producing a pressure difference between the right and left pressure chamber.

Next, the structure of the core is described.

Core inner channel 124 is formed by combining core lid 122 with core main body 120. Core inner channel 124 communicates with water discharge channel 182 provided in water discharge tubular body 180. Core main body 120 and core lid 122 have introducing ports 132, 134 allowing core inner channel 124 to communicate with pressure chambers 116, 118. Valve bodies 352, 354 are provided so as to traverse core inner channel 124.

As shown in FIG. 11, right and left valve body 352, 354 are coupled to each other across leaf spring 160, and provided through introducing ports 132, 134 so as to move from side to side. Leaf spring 160 is supported at both ends by core main body 120. Valve bodies 352, 354 move relative to the core via leaf spring 160. Valve bodies 352, 354 are biased by compressed leaf spring 160 and control introducing port 132, 134 to one of the fully open state and the fully closed state alternatively.

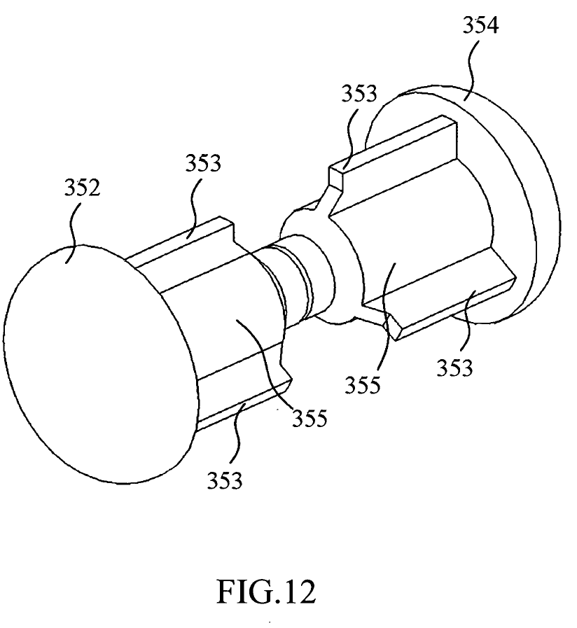

FIG. 12 is a perspective view showing the valve bodies. Ribs 353 are formed on valve bodies 352, 354 so that valve bodies 352, 354 move coaxially with respect to introducing ports 132, 134. When valve bodies 352, 354 move away from core lid 122 and core main body 120, respectively, groove portion 355 provided between ribs 353 become the opening portion of introducing ports 132, 134 and form a channel for fluid.

On the other hand, magnet 370 is embedded in the core. Correspondingly, magnets (or ferromagnets) 374, 372 are embedded in housing main body 102 and housing lid 104, respectively. In the example shown, magnets 374, 372 are configured as a circle so that the core can rotate aboutwater discharge tubular body 180.

As illustrated in FIGS. 9 to 11, when valve body 354 is biased away from core main body 120, introducing port 134 is opened. Conversely, when valve body 352 is biased away from core lid 122, introducing port 132 is opened.

In this embodiment, by providing the attractive force between magnet 370 and magnet 372, 374, leaf spring 160 is reliably reversed to bias valve bodies 352, 354, and thereby introducing port 132, 134 can be controlled to be in one of the fully open state and the fully closed state alternatively.

In the following, the action of the water discharger of this embodiment is described.

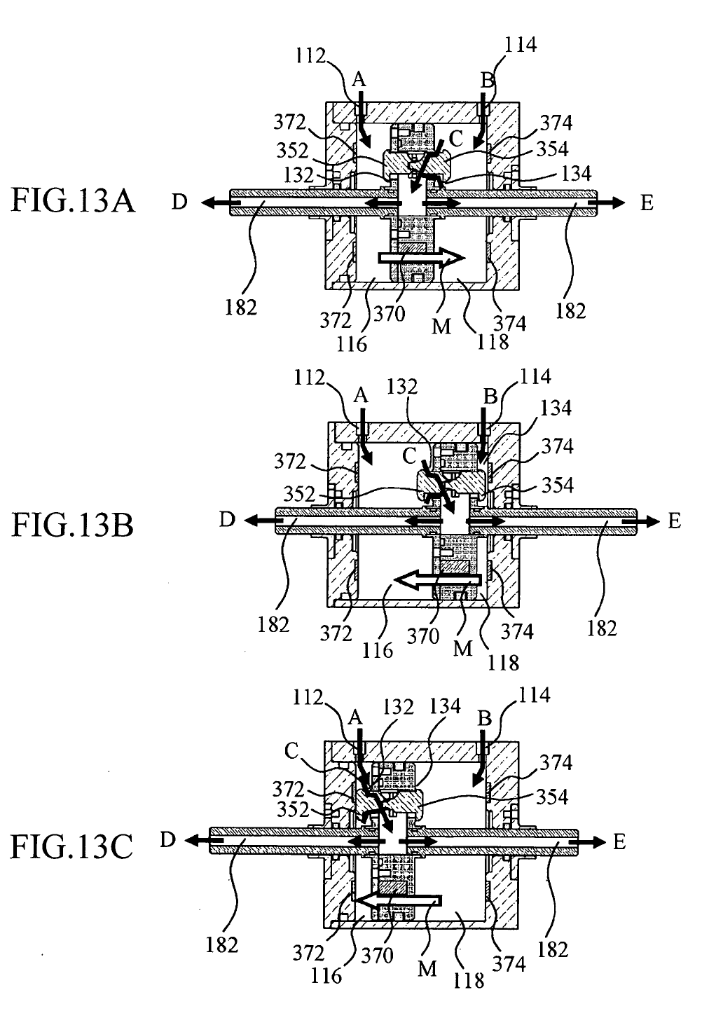

FIG. 13 is a schematic view showing the reciprocating linear motion of the water discharger of this embodiment. As with the water discharger described above with reference to FIGS. 1 to 5, the core reciprocates linearly in this embodiment as well.

More specifically, in the state of FIG. 13(a), valve bodies 352, 354 are biased to the right side by the biasing force of leaf spring 160, closing introducing port 132 and opening introducing port 134. In this state, when fluid such as water is supplied to water inlet ports 112, 114 at nearly the same pressure, the water introduced from water inlet port 114 into pressure chamber 118 as shown by arrow B flows from introducing port 134 into core inner channel 124 as shown by arrow C and flows out as shown by arrows D, E via water discharge channel 182 communicating both side of the core inner channel 124.

On the other hand, because introducing port 132 is closed, the water introduced from water inlet port 112 into pressure chamber 116 as shown by arrow A has no outflow path and increases the pressure in pressure chamber 116.

That is, by providing an opening difference between introducing ports 132, 134, a difference in channel resistance occurs, which causes a pressure difference. As a result, the pressure becomes higher in pressure chamber 116 than in pressure chamber 118, and the core is pushed and moved in the direction of arrow M.

When the core moves in the direction of arrow M, the volume of pressure chamber 116 increases, and the volume of pressure chamber 118 decreases by that amount. Therefore the fluid in pressure chamber 118 is pushed out by the amount of fluid flowing into pressure chamber 116 via the path of arrow A, and is included in the discharge amount of fluid flowing out of channel 182.

When the core further continues to move, valve body 354 abuts against the inner wall of housing main body 102 and pushed against the core. At this time, an attractive force acts between magnet 370 embedded in the core and magnet 374 provided in housing main body 102, and the core is pulled to the right side. By the synergy of these effects, the core moves toward the right end of housing main body 102, and valve body 354 is pushed against the core. Thus the bend direction of leaf spring 160 is reversed, and valve bodies 352, 354 are biased toward the left side as shown in FIG. 13(b). That is, introducing port 132 is opened, and introducing port 134 is closed.

In the state shown in FIG. 13(b), the fluid introduced from water inlet port 112 into pressure chamber 116 as shown by arrow A flows out via introducing port 132. On the other hand, because introducing port 134 is closed, the fluid introduced from water inlet port 114 into pressure chamber 118 as shown by arrow B has no outflow path and increases the pressure in pressure chamber 118. As a result, the core begins to move toward the left side as shown by arrow M.

As shown in FIG. 13(c), the core moves to the position where valve body 352 abuts against the inner wall of housing lid 104. From this state, the core moves further and begins to push leaf spring 160. At the same time, the attractive force acting between magnet 370 embedded in the core and magnet 372 provided in housing lid 104 pulls the core further to the left side. As a result, valve body 352 is pushed against the core to reverse the bend direction of leaf spring 160, and valve bodies 352, 354 are biased to the opposite direction.

As described above, according to this embodiment, the attractive force acting between magnet 370 embedded in the core and magnet 374, 372 provided in housing main body 102 and housing lid 104 is used to invert the size relation of the opening difference between the introducing ports, thereby reversing the magnitude difference of channel resistance. Thus the pressure difference is reversed, and the core can be moved right and left repetitively.

Next, the function of the control means in this embodiment is described in more detail.

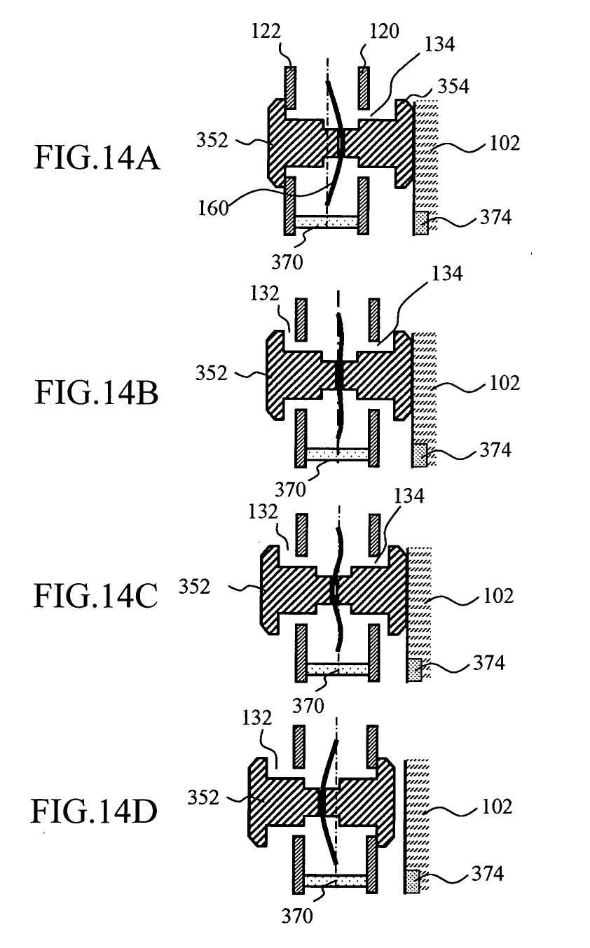

FIG. 14 is a schematic view for describing the operation of the control means in this embodiment.

More specifically, FIG. 14(a) shows the instance when valve body 354 abuts against the inner wall of housing main body 102. At this time, leaf spring 160 is bent to the right side, and introducing port 134 has a larger opening than introducing port 132. Therefore a hydraulic pressure is applied to the core toward the right side.

From this state, when the core moves further to the right side against the biasing force of leaf spring 160, valve body 354 is pushed against the core, and the opening of introducing port 132 becomes nearly equal to the opening of introducing port 134 as shown in FIG. 14(b). That is, a state occurs where no driving force due to hydraulic pressure is applied to the core. At this time, leaf spring 160 is also pushed to the left side and deformed. However, leaf spring 160 may fall into a metastable, neutral state with a generally S-shaped configuration as illustrated in this figure. Alternatively, leaf spring 160 may be halfway between the state shown in FIG. 14(a) and the state shown in FIG. 14(b). That is, the core may stop while leaf spring 160 cannot be reversed to the left side.

In contrast, in this embodiment, the core can be pulled to the right side by the attractive force acting between magnet 370 embedded in the core and magnet 374 provided in housing main body 102. That is, as shown in FIG. 14(b), at the stage when introducing port 132 begins to open due to the action of valve body 352, the core can be pulled to the right side by the effect of magnetic force.

As the core is pulled to the right side, leaf spring 160 gets out of the metastable neutral state and begins to be reversed to the left side as shown in FIG. 14(c). Then, as shown in FIG. 14(d), when it is reversed to the state bent to the left side, a state occurs where introducing port 132 is fully opened by the action of valve body 352 and introducing port 134 is closed by the action of valve body 354.

Subsequently, because a pressure difference occurs between both sides of the core, the core moves toward the left side. Note that the driving force due to the pressure difference at this time needs to be configured so as to exceed the attractive force between magnet 370 and magnet 374.

As described above, according to this embodiment, by using the attractive force between magnet 370 and magnet 372, 374 to pull the core, valve bodies 352, 354 can be pushed against the core to reliably reverse leaf spring 160. That is, the state of valve bodies 352, 354 can be controlled using the attractive force of the magnet to invert the size relation of the opening difference between introducing ports 132 and 134, thereby reversing the magnitude difference of channel resistance. Thus the pressure difference is reversed, and a smooth reciprocating linear motion can be achieved.

Furthermore, the moving direction of the core, the movable direction of valve bodies 352, 354, the biasing direction of leaf spring 160, and the acting direction of the attractive force of magnets 370, 372, 374 can be made generally the same to avoid waste in the action of force and to effectively use the moving force of the core having a large pressure-receiving area. Thus a smooth and stable action is achieved. That is, the moving action and the opening control action of the core are interlocked, and the control action to invert the size relation of the opening of introducing ports 132, 134 for the reversal of the core is made reliable and easy. Thus the valve bodies and the control means are made simple and compact.

Furthermore, in this configuration, even when water discharge is started from the state where the core is stopped about halfway through its moving stroke, valve bodies 352, 354 can be controlled by leaf spring 160 at the beginning of water discharge to be in the state where one of introducing ports 132, 134 is opened alternatively. Thus a pressure difference is produced between both sides of the core, and a stable initial action can be started. That is, the state where the opening of introducing port 134 is larger than the opening of introducing port 132, or the state where the opening of introducing port 132 is larger than the opening of introducing port 134, can be retained alternatively.

In the case of the water discharger of this embodiment, as shown in FIG. 9 and the like, seal 184 between water discharge tubular body 180 and housing main body 102 (housing lid 104) is provided on the side of housing main body 102 (housing lid 104). Therefore its size in the direction of the stroke can be shortened, which leads to downsizing.

In the case of this embodiment, while valve bodies 352, 354 abut against the inner wall of the housing when the core is reversed, the invention is not limited thereto. For example, valve bodies 352, 354 can be provided with a magnet, the inner wall of the housing can also be provided with a magnet, and the repulsive force acting therebetween can be used to stop valve bodies 352, 354 relative to the housing. That is, in this case, in the state corresponding to FIGS. 14(a) to 14(c), valve body 354 does not abut against the inner wall of housing 102, but is located at a prescribed distance apart from the inner wall of housing 102 by the repulsive force of the magnets (not shown). Thus the core can be reversed in a noncontact manner.

Furthermore, in this embodiment, the thrust obtained in the reciprocating linear action is determined by the product of the pressure of fluid loaded on the core and the pressure-receiving area of the core. Therefore, as the pressure-receiving area of the core is increased, a larger thrust can be obtained correspondingly.

While FIGS. 9 to 11 and FIG. 14 show an example where a circular core is contained in a generally cylindrical space provided in the housing, the invention is not limited thereto. For example, the interior space of housing main body 102 may be shaped as a rectangular cylinder or a flattened cylinder, and the core may have any of various shapes correspondingly.

The outer peripheral shape of water discharge tubular body 180 does not need to be circular, but may be in a polygonal or flattened shape. Furthermore, water discharge tubular body 180 does not need to be placed at the center of the core, but may be decentered from the center of the core. This facilitates downsizing the core, and the water discharger can be downsized.

When the housing inner space is configured as a cylinder and water discharge tubular body 180 is placed at the center of the cylindrical core as in this example, water discharge tubular body 180 can be rotated. That is, when a water discharge nozzle is provided at the tip of water discharge tubular body 180, the reciprocating linear motion of the core allows the water discharge position to be repetitively changed, and at the same time water discharge tubular body 180 can be rotated to change the water discharge direction as well. For example, a cam structure or the like composed of a protrusion and a groove can be provided to rotate the core and the water discharge tubular body about the central axis thereof simultaneously with the movement of the core. In this way, various modes of water discharge depending on the user's preference can be achieved.

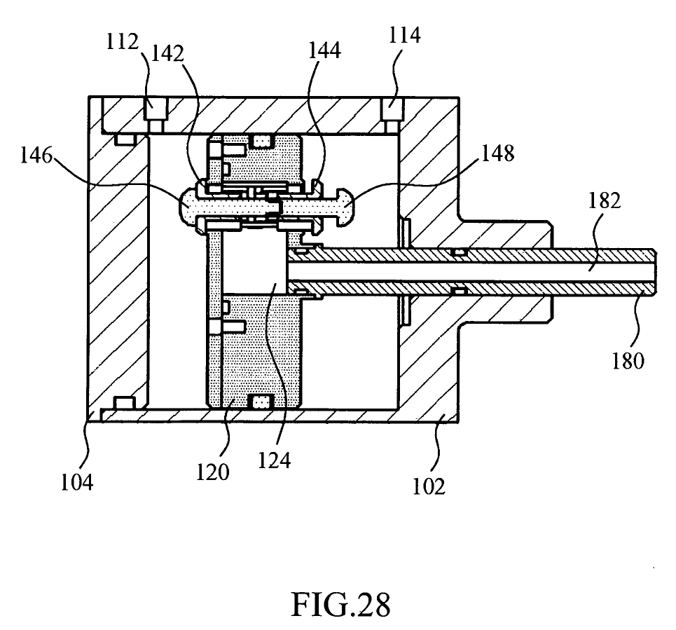

Furthermore, in this embodiment, as described later with reference to FIG. 28, water discharge tubular body 180 may be provided only on one end of core main body 120. This is particularly useful when water discharge only from one end is desired.

Next, as a second embodiment of the invention, a water discharger having a control means including a magnet and a leaf spring in combination for reciprocating rotary motion is described.

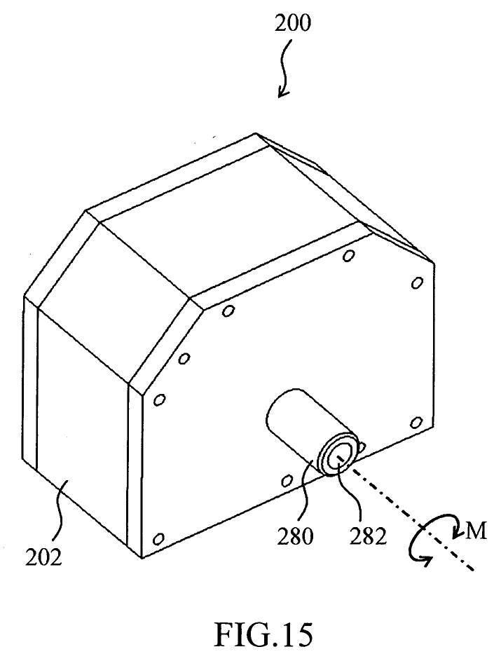

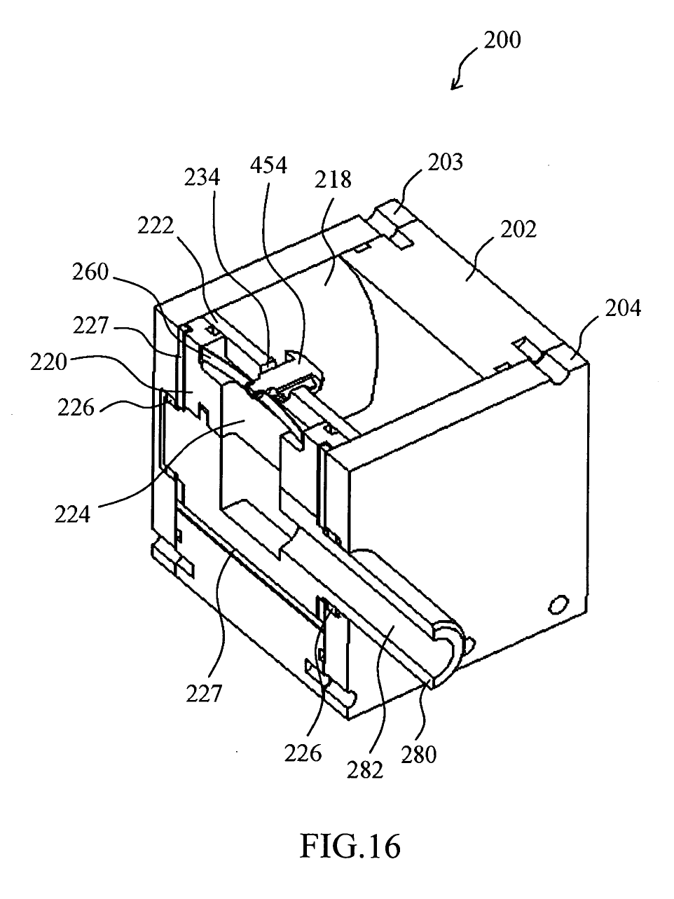

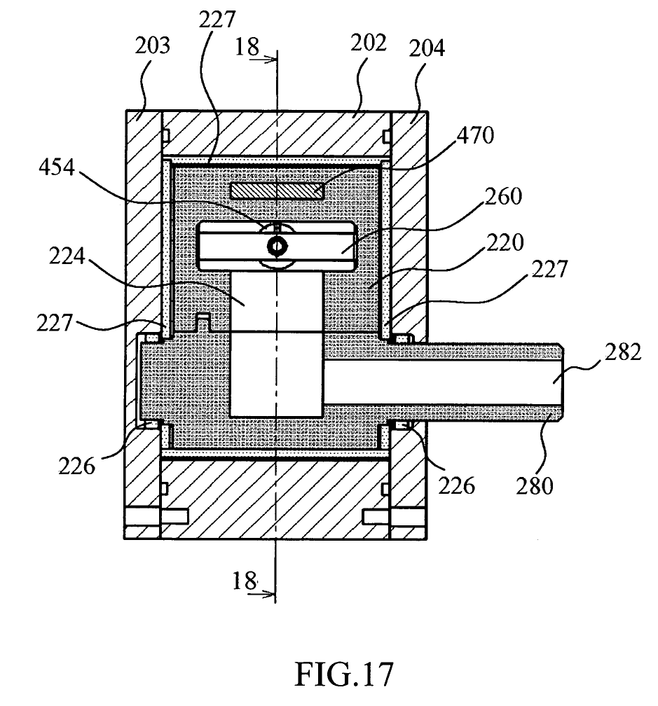

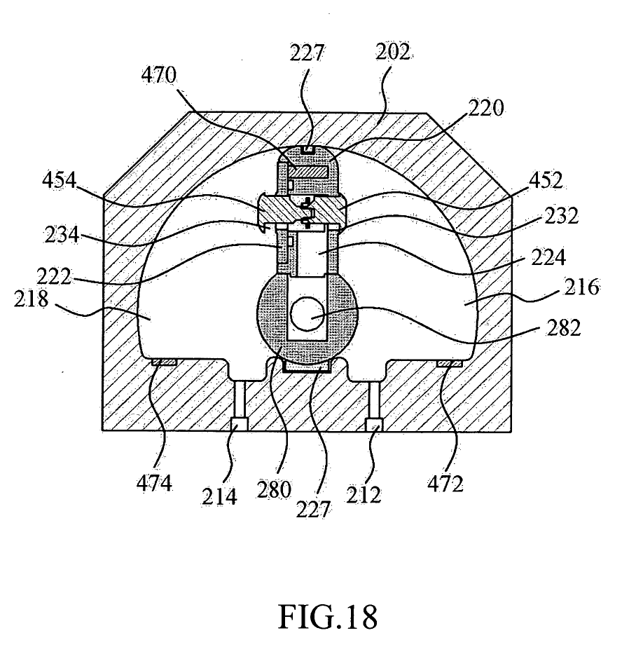

FIGS. 15 to 18 are schematic views showing the relevant part of a water discharger according to the second embodiment of the invention. More specifically, FIG. 15 is a perspective view of the water discharger of this embodiment, FIG. 16 is a perspective cutaway view thereof, FIG. 17 is a vertical cross section, and FIG. 18 is a cross section along line 18-18 in FIG. 17.

Water discharger 200 of this embodiment has water discharge tubular body 280 that illustratively protrudes on one side from a housing formed from housing main body 202 and housing lids 203, 204. Water discharge tubular body 280 has a hollow structure having water discharge channel 282 inside and opened at the tip. When fluid such as water is introduced into water inlet ports 212, 214 provided in housing main body 202, water discharge tubular body 280 rotates repetitively in the direction of arrow M. Therefore a water discharger having a repetitively changing water discharge direction can be constructed by providing a water discharge nozzle such as a shower nozzle at the tip of water discharge tubular body 280.

The internal structure is described. As shown in FIGS. 16 to 18, a core composed of core main body 220 and core lid 222 is contained in a fan-shaped housing space formed from housing main body 202 and housing lids 203, 204, where the core is able to oscillate about tubular body 280. That is, the core is coupled to water discharge tubular body 280 penetrating in the housing, and is oscillated, dividing the interior of the fan-shaped housing into first pressure chamber 216 and second pressure chamber 218. Fluid such as water is introduced from water inlet ports 212, 214 into pressure chambers 216, 218, respectively. The sliding portion between core main body 220 and the inner wall of housing main body 202 and housing lids 203, 204 is provided with seal 227 for facilitating sliding while maintaining liquid tightness. The sliding portion between water discharge tubular body 280 and housing lids 203, 204 is also provided with seal 226 for the same purpose. Seals 227, 226 can again be made of such materials as Teflon®, NBR (nitrile rubber), EPDM (ethylene-propylene rubber), and POM (polyacetal). “Liquid tightness” used herein can be satisfied by ensuring the condition sufficient for producing a pressure difference between the right and left pressure chamber.

Next, the structure of the core is described.

In this embodiment again, the core has a control means similar to that in the first embodiment.

More specifically, core inner channel 224 is formed by combining core lid 222 with core main body 220. Core inner channel 224 communicates with water discharge channel 282 provided in water discharge tubular body 280. Core main body 220 and core lid 222 have introducing ports 232, 234 allowing core inner channel 224 to communicate with the pressure chambers 216, 218.

As shown in FIGS. 16 and 17, the both sides of valve body 452, 454 are coupled to each other across leaf spring 260, and provided through introducing ports 232, 234, which are provided in core main body 220 and core lid 222, so as to move from side to side. Leaf spring 260 is supported at both ends by core main body 220. Valve bodies 452, 454 move to the core via leaf spring 260. Compressed leaf spring 260 and valve bodies 452, 454 control introducing port 232, 234 to one of the fully open state and the fully closed state alternatively. The shape of valve bodies 452, 454 is as described above with reference to FIG. 12.

On the other hand, magnet 470 is embedded in core main body 220. Correspondingly, magnets (or ferromagnets) 474, 472 are embedded in housing main body 202.

As illustrated in FIGS. 16 and 18, when valve body 454 is biased away from core main body 220, introducing port 234 is opened. Conversely, when valve body 452 is biased away from core lid 222, introducing port 232 is opened.

In this embodiment again, by providing the attractive force between magnet 470 and magnet 472, 474, leaf spring 260 is reliably reversed to bias valve bodies 452, 454, and thereby introducing ports 232, 234 is controlled to be in one of the fully open state and the fully closed state alternatively.

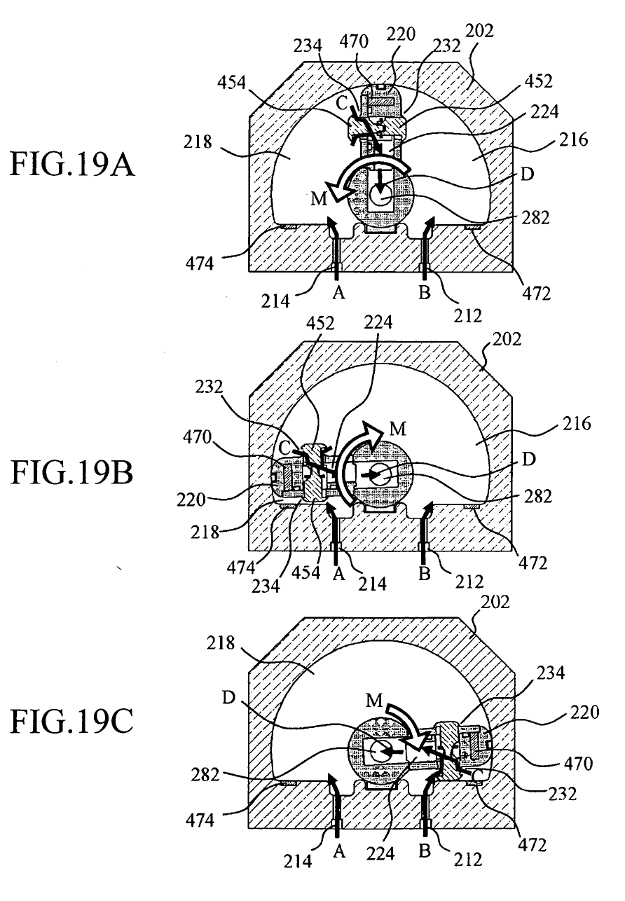

FIG. 19 is a schematic view showing the oscillating action of the water discharger of this embodiment. Core main body 220 rotates about water discharge tubular body 280 in this embodiment.

First, FIG. 19(a) shows a state where valve bodies 452, 454 are biased to the left side by leaf spring 260. At this time, a state occurs where introducing port 232 is closed and introducing port 234 is opened.

In this state, when fluid such as water is supplied to water inlet ports 212, 214 at nearly the same pressure, the water introduced from water inlet port 214 into pressure chamber 218 as shown by arrow A flows from introducing port 234 into core inner channel 224 as shown by arrow C and flows out as shown by arrow D via water discharge channel 282.

On the other hand, because introducing port 232 is closed, the water introduced from water inlet port 212 into pressure chamber 216 as shown by arrow B has no outflow path and increases the pressure in pressure chamber 216.

That is, by providing an opening difference between introducing ports 232 and 234, a difference in channel resistance occurs, which causes a pressure difference. As a result, the pressure becomes higher in pressure chamber 216 than in pressure chamber 218, and core is pushed and oscillated in the direction of arrow M.

When the core moves in the direction of arrow M, the volume of pressure chamber 216 increases, and the volume of pressure chamber 218 decreases by that amount. Therefore the fluid in pressure chamber 218 is pushed out by the amount of fluid flowing into pressure chamber 216 via the path of arrow A, and is included in the discharge amount of fluid flowing out of channel 282.

When the core further continues to oscillate and valve body 454 abuts against the inner wall of housing main body 202 and pushed against the core, leaf spring 260 is also pushed in the direction of reversing its bend direction. At this time, an attractive force acts between magnet 470 provided in core main body 220 and magnet 474 provided in housing main body 202, and the core is pulled to the inner wall of housing main body 202. Then valve body 454 is pushed further, and correspondingly leaf spring 260 is pushed. Thus the bend direction of leaf spring 260 is reversed. Then, as shown in FIG. 19(b), introducing port 234 is closed by valve body 454, and introducing port 232 is fully opened by valve body 452. The details of this control operation are similar to those described above with reference to FIG. 14.

In the state shown in FIG. 19(b), the fluid introduced from water inlet port 212 into pressure chamber 216 as shown by arrow B flows through introducing port 232 into core inner channel 224 as shown by arrow C and flows out via water discharge channel 282 as shown by arrow D. On the other hand, because introducing port 234 is closed, the fluid introduced from water inlet port 214 into pressure chamber 218 as shown by arrow A has no outflow path and increases the pressure in pressure chamber 218. As a result, a pressure difference occurs between pressure chambers 216 and 218, and the core begins to oscillate toward the right side as shown by arrow M.

As shown in FIG. 19(c), the core oscillates, and then valve body 452 abuts against the inner wall of housing main body 202. At this time, an attractive force acts between magnet 470 provided in the core and magnet 472 provided in housing main body 202, and the core is pulled to the inner wall of housing main body 202. Then valve body 452 is pushed further against the core, and correspondingly leaf spring 260 is pushed. Thus the bend direction of leaf spring 260 is reversed. Then, like the state shown in FIG. 19(a), introducing port 232 is closed by valve body 452, and introducing port 234 is opened by valve body 454. Thus the core begins to oscillate toward the left side. Subsequently, the states shown in FIGS. 19(a) to 19(c) are repeated, and thereby the core continues a reciprocating rotary motion.

As described above, in this embodiment again, by using the attractive force between magnet 370 and magnets 372, 374 to pull core main body 220, valve bodies 452, 454 can be pushed to reliably reverse leaf spring 260. That is, the state of valve bodies 452, 454 can be controlled using the attractive force of the magnet to invert the size relation of the opening between the introducing ports, thereby reversing the magnitude difference of channel resistance. Thus the pressure difference is reversed, and a smooth reciprocating rotary motion can be achieved.

Furthermore, the oscillating direction of the core, the movable direction of valve bodies 452, 454, the biasing direction of leaf spring 260, and the acting direction of the attractive force of magnets 370, 372, 374 can be made generally the same to avoid waste in the action of force and to effectively use the moving force of the core having a large pressure-receiving area. Thus a smooth and stable action is achieved. That is, when the core approaches the inner wall of housing main body 202, the moving direction of the core is made generally the same as the movable direction of valve bodies 452, 454, the biasing direction of leaf spring 260, and the acting direction of the attractive force of magnets 370, 372, 374. Thus the oscillating action and the opening control action of the core are interlocked, and the control action to invert the size relation of the opening of introducing ports 232, 234 for the reversal of the core is made reliable and easy. Thus the valve bodies and the control means are made simple and compact.

Furthermore, in this configuration, even when water discharge is started from the state where the core is stopped about halfway through its oscillating stroke, valve bodies 452, 454 can be controlled by leaf spring 260 at the beginning of water discharge to be in the state where one of introducing ports 232, 234 is opened alternatively. Thus a pressure difference is produced between both sides of the core, and a stable initial action can be started. That is, the state where the opening of introducing port 234 is larger than the opening of introducing port 232, or the state where the opening of introducing port 232 is larger than the opening of introducing port 234, can be retained alternatively.

The stroke (oscillating angle) of the oscillating motion of the core in this embodiment can be appropriately configured by the opening angle of the fan-shaped space of housing main body 202. Furthermore, in this embodiment again, the thrust obtained by the oscillating action is determined by the product of the pressure of fluid applied to the core and the pressure-receiving area of the core. Therefore, as the pressure-receiving area of the core is increased, a correspondingly larger thrust can be obtained.

While FIGS. 15 to 19 show an example where water discharge tubular body 280 protrudes only on one side of the housing, the invention is not limited thereto. As with that described above with reference to the first embodiment, water discharge tubular bodies 280 may protrude on both sides of the housing to provide water discharge from each of water discharge tubular bodies 280.

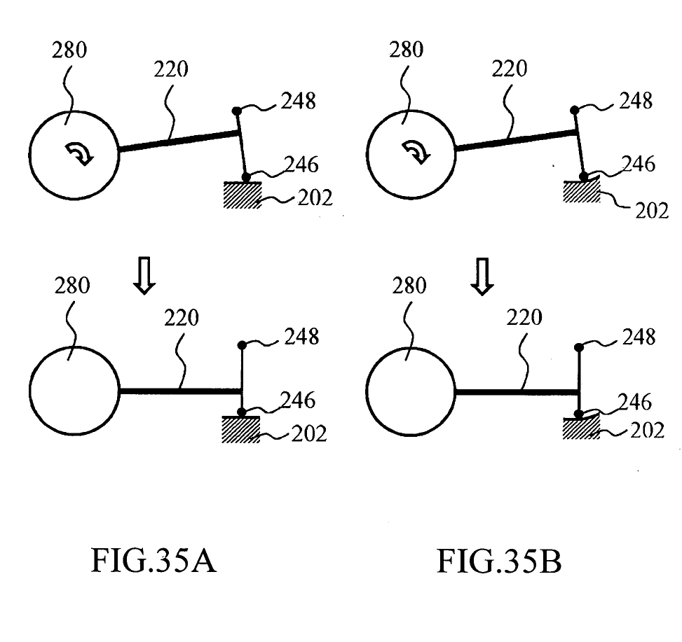

As described later in detail with reference to FIG. 35, in this embodiment again, because the core oscillates rather than moves linearly, it is advantageous to adjust the abutment angle between valve bodies 452, 454 and the inner wall of housing main body 202.

More specifically, by forming the abutment surface of the inner wall of housing main body 202 in a curved concave shape, valve bodies 452, 454 can be always in perpendicular abutment in accordance with the oscillation of the core. That is, valve bodies 452, 454 can be smoothly slid. Thus the reversal control operation can be made smooth and more reliable. This point will be described later in detail with reference to FIG. 35.

In this embodiment again, while valve bodies 452, 454 abuts against the inner wall of the housing when the core is reversed, the invention is not limited thereto. For example, valve bodies 452, 454 can be provided with a magnet, the inner wall of housing main body 202 can also be provided with a magnet, and the repulsive force acting therebetween can be used to stop valve bodies 452, 454 relative to the inner wall of housing main body 202. That is, in this case, when the core is reversed, valve bodies 452, 454 do not abut against the inner wall of housing main body 202, but is located at a prescribed distance apart from the inner wall of housing main body 202 by the repulsive force of the magnets. Thus the core can be reversed in a noncontact manner, and valve bodies 452, 454 can be smoothly slid irrespective of the shape of the abutment surface of the inner wall of housing main body 202.

In the foregoing, as the first and second embodiment of the invention, water dischargers having a control means including a leaf spring and a magnet in combination have been described.

Next, as a third and fourth embodiment of the invention, water dischargers having a control means including a leaf spring and a slide bar in combination are described.

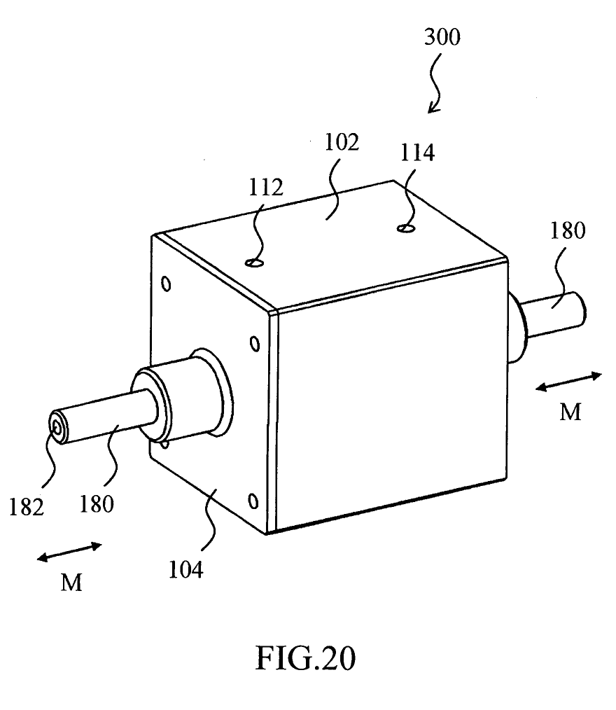

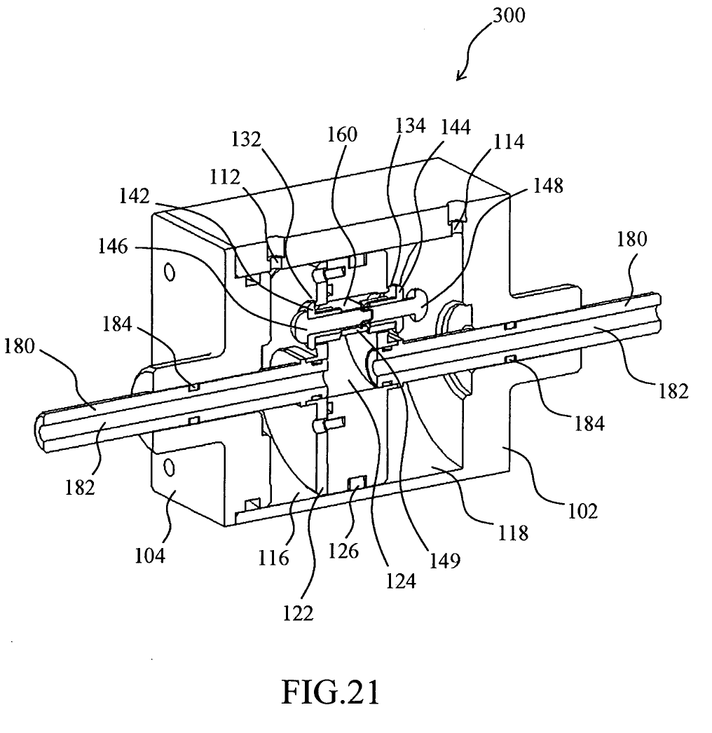

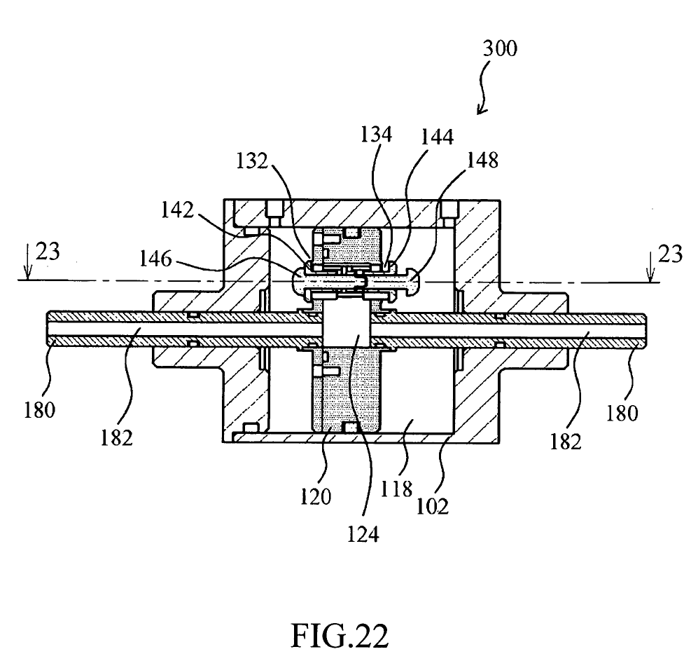

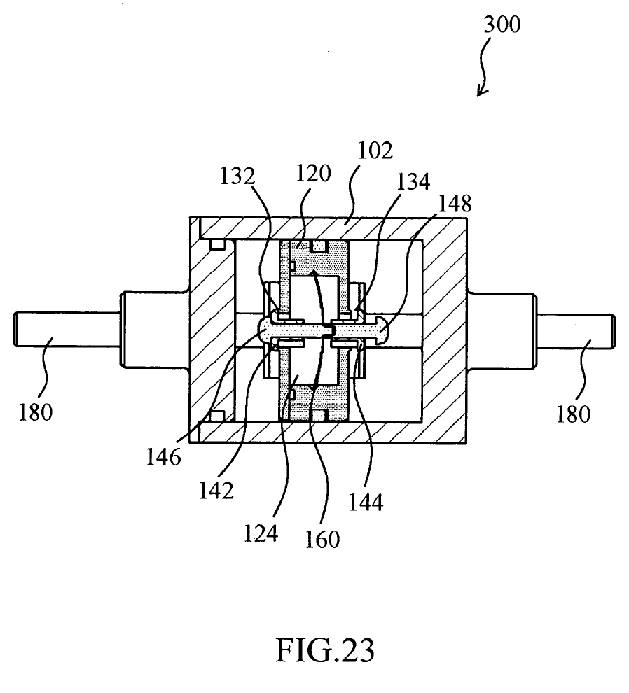

FIGS. 20 to 23 are schematic views showing the relevant part of a water discharger of the third embodiment of the invention. More specifically, FIG. 20 is a perspective view of the water discharger of this embodiment, FIG. 21 is a perspective cutaway view thereof, FIG. 22 is a cross section, and FIG. 23 is a cross section along line 23-23 in FIG. 22.

Water discharger 300 of this embodiment has a structure similar to that of the first embodiment. Hence elements similar to those described above with reference to FIGS. 8 to 14 are marked with the same reference numerals and not described in detail.

Water discharger 300 of this embodiment also has water discharge tubular body 180 that illustratively protrudes from both sides of a housing formed from housing main body 102 and housing lid 104. When fluid such as water is introduced into water inlet ports 112, 114 provided in housing main body 102, water discharge tubular body 180 protruding to both sides and reciprocate in the direction of arrow M.

In this embodiment, a leaf spring and a slide bar are provided as a control means in the core.

More specifically, core inner channel 124 is formed by combining core lid 122 with core main body 120. Core inner channel 124 communicates with water discharge channel 182 provided in water discharge tubular body 180. Core main body 120 and core lid 122 have introducing ports 132, 134 allowing core inner channel 124 to communicate with pressure chambers 116, 118. Main valves 142, 144 and slide bars 146, 148 are provided so as to traverse core inner channel 124.

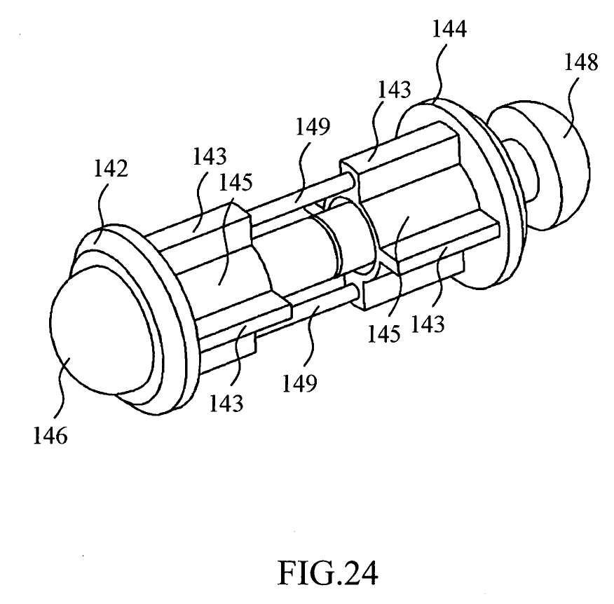

FIG. 24 is a perspective view showing the main valves and the slide bars.

The right and left main valves 142, 144 are coupled to each other by coupling rods 149, and provided through introducing ports 132, 134 provided in core main body 120 and core lid 122 so as to move from side to side. That is, main valves 142, 144 as valve bodies are provided so as to move from side to side relatively to core main body 120 with a prescribed stroke. Ribs 143 are formed on main valves 142, 144 so that main valves 142, 144 move coaxially with respect to introducing ports 132, 134. When main valves 142, 144 move away from core lids 122, 120, respectively, groove portion 145 provided between ribs 143 becomes the opening portion of introducing ports 132, 134 and forms a channel for fluid. Furthermore, slide bars 146, 148 coaxially penetrating main valves 142, 144 are also provided so as to move from side to side. That is, slide bars 146, 148 are provided so as to move from side to side with a longer stroke than the action stroke of main valves 142, 144.

As illustrated in FIGS. 21 to 23, when main valve 144 is moved away from core main body 120, introducing port 134 is opened. Conversely, when main valve 142 is moved away from core lid 122, introducing port 132 is opened.

Introducing ports 132, 134 both communicate with core inner channel 124. That is, introducing port 132 allows pressure chamber 116 in the housing to communicate with core inner channel 124, and introducing port 134 allows pressure chamber 118 to communicate with core inner channel 124.

The action of main valves 142, 144 to vary the opening of introducing ports 132, 134 is determined by the coaxially installed slide bars 146, 148. More specifically, as shown in FIG. 23, both sides of slide bar 146, 148 are coupledto each other across compressed leaf spring 160, and subjected to a biasing force toward the right end or the left end depending on the bend direction of leaf spring 160. Leaf spring 160 is supported at both ends by core main body 120. Slide bars 146, 148 move relatively to core main body 120 via leaf spring 160. Main valves 142, 144 are subjected to the biasing force from slide bars 146, 148 to place introducing ports 132, 134 to one of the fully open state and the fully closed state alternatively. That is, slide bars 146, 148 and leaf spring 160 act as a control means to control main valves 142, 144 as valve bodies.

In the following, the action of the water discharger of this embodiment is described.

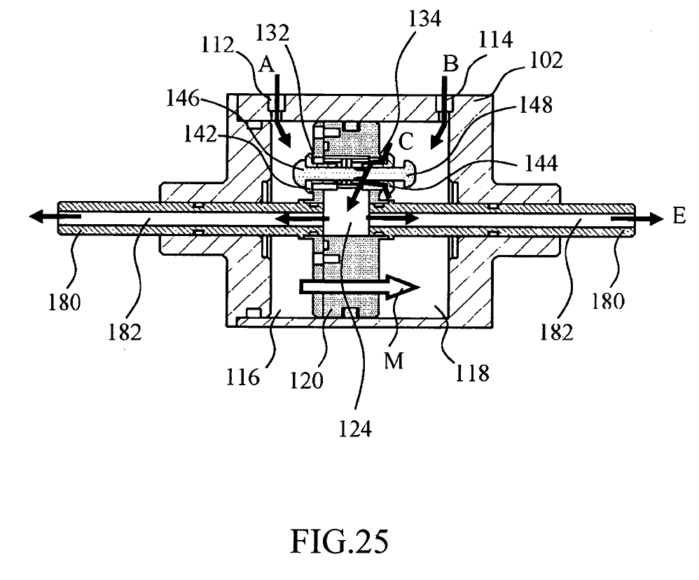

FIG. 25 is a schematic view for describing the action of the water discharger of this embodiment.

More specifically, this figure shows a state where slide bars 146, 148 are biased toward the right side under the action of leaf spring 160. At this time, because main valves 142, 144 are also biased toward the right side by slide bar 146, a state occurs where introducing port 132 is closed and introducing port 134 is opened.

In this state, when fluid such as water is supplied to water inlet ports 112, 114 at nearly the same pressure, the water introduced from water inlet port 114 into pressure chamber 118 as shown by arrow B flows from introducing port 134 into core inner channel 124 as shown by arrow C and flows out as shown by arrows D, E via water discharge channel 182, 182 communicating both sides.

On the other hand, because introducing port 132 is closed, the water introduced from water inlet port 112 into pressure chamber 116 as shown by arrow A has no outflow path and increases the pressure in pressure chamber 116.

That is, by providing an opening difference between introducing ports 132, 134, a difference in channel resistance occurs, which causes a pressure difference. As a result, the pressure becomes higher in pressure chamber 116 than in pressure chamber 118, and the core is pushed and moved in the direction of arrow M.

When the core moves in the direction of arrow M, the volume of pressure chamber 116 increases, and the volume of pressure chamber 118 decreases by that amount. Therefore the fluid in pressure chamber 118 is pushed out by the amount of fluid flowing into pressure chamber 116 via the path of arrow A, and is included in the discharge amount of fluid flowing out of channel 182.

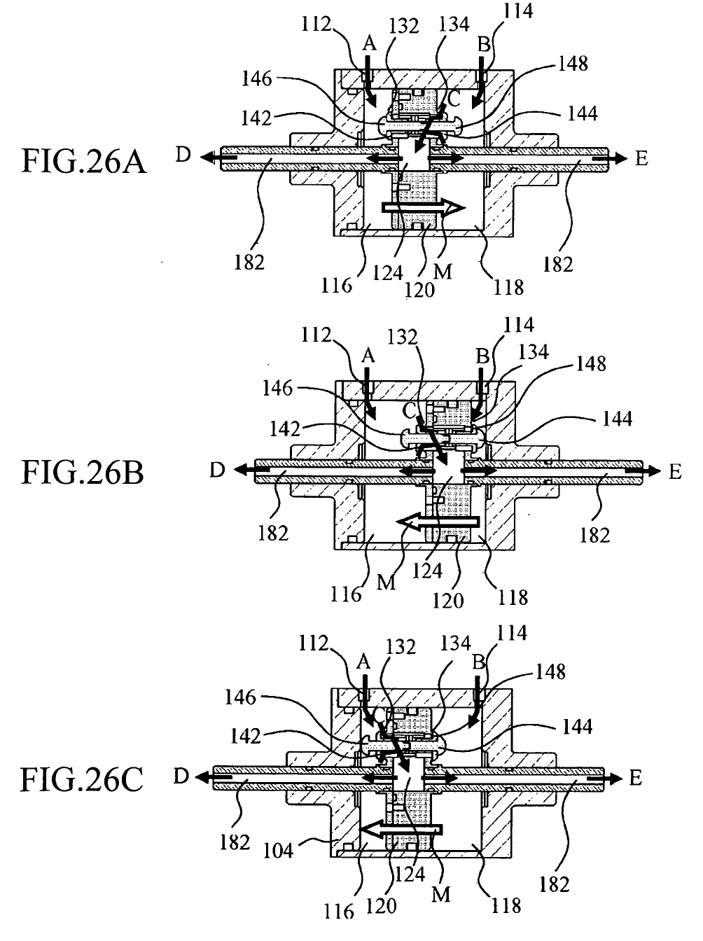

FIG. 26 is a schematic view showing the reciprocating action of the water discharger of this embodiment.

More specifically, FIG. 26(a) shows the same state as that described above with reference to FIG. 25, where the core moves to the right side as shown by arrow M. As the movement continues, slide bar 148 abuts against the inner wall of housing main body 102 and pushed against the core. Then the bend direction of leaf spring 160 is reversed, and slide bars 146, 148 are biased toward the left side as shown in FIG. 26(b). Then slide bar 148 pushes main valve 144, and thereby main valves 142, 144 are also moved to the left side. That is, introducing port 132 is opened, and introducing port 134 is closed.

In the state shown in FIG. 26(b), the fluid introduced from water inlet port 112 into pressure chamber 116 as shown by arrow A flows through introducing port 132 into core inner channel 124 as shown by arrow C and flows out via water discharge channel 182, as shown by arrows D, E. On the other hand, because introducing port 134 is closed, the fluid introduced from water inlet port 114 into pressure chamber 118 as shown by arrow B has no outflow path and increases the pressure in pressure chamber 118. As a result, a pressure difference occurs between pressure chambers 116 and 118, and the core begins to move toward the left side as shown by arrow M.

As shown in FIG. 26(c), the core continues to move to the position where slide bar 146 abuts against the inner wall of housing lid 104. From this state, the core moves further, and slide bar 146 is pushed against the core to reverse the bend direction of leaf spring 160, which is thus biased to the right side. Then, like the state shown in FIG. 26(a), introducing port 132 is closed, introducing port 134 is opened, and the core begins to move toward the right side.

As described above, according to this embodiment, because the core is provided with main valves 142, 144 as valve bodies and with a control means composed of slide bars 146, 148 and leaf spring 160, that the size relation of the opening Obetween introducing ports 132 and 134 can be appropriately inverted depending on the movement of core main body 120. Thus core is able to reciprocate. The stroke of reciprocation of the core in the water discharger of this embodiment can be configured appropriately on the basis of the length of housing main body 102 and the thickness (width) of the core.

Next, the function of the control means in this embodiment is described in more detail.

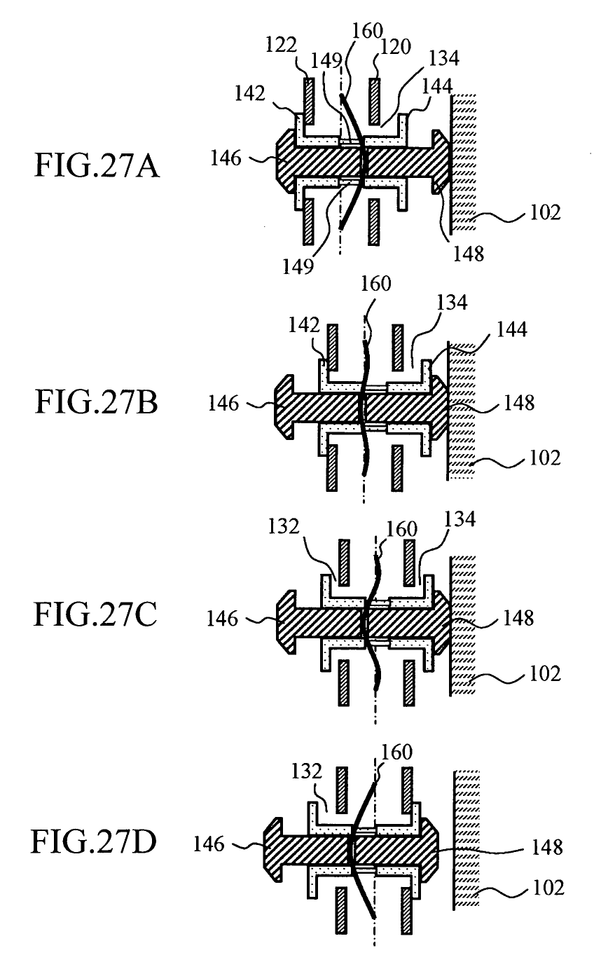

FIG. 27 is a schematic view for describing the operation of the control means in this embodiment.

More specifically, FIG. 27(a) shows the state where leaf spring 160 is bent to the right side to bias slide bars 146, 148 in this direction. At this time, introducing port 132 is closed by main valve 142, and introducing port 134 is opened by main valve 144.

In this state, as the core moves to the right side, slide bar 148 abuts against the inner wall of the housing as shown in this figure. Because a pressure difference is acting on the core, the core moves further to the right with slide bar 148 abutting against the housing inner wall, and results in the state shown in FIG. 27(b). That is, the relative position of the core and slide bar 148 is varied against the biasing force of leaf spring 160, and slide bar 148 is pushed against the core. As a result, leaf spring 160 is also pushed to the left side and deformed to take a generally S-shaped configuration as illustrated in this figure. At this time, main valves 142, 144 are subjected to the pressure difference like the core and do not change the open/closed state of introducing ports 132, 134.

Subsequently, the core moves further, and thereby slide bar 148 is further pushed against the core. Then, as shown in FIG. 27(c), leaf spring 160 begins to reverse its bend direction to the left side and biases slide bars 146, 148 to the left side.

Then, as shown in FIG. 27(d), main valves 142, 144 are moved to the left side by the biasing force of leaf spring 160. Thus introducing port 132 is fully opened, and introducing port 134 is fully closed.

As described above, in this embodiment, the bend direction of compressed leaf spring 160 is appropriately reversed by slide bars 146, 148, and its biasing force is used to operate main valves 142, 144, thereby alternatively controlling introducing ports 132, 134 to be in one of the fully open state and the fully closed state. That is, the biasing force of leaf spring 160 is used to reliably produce the opening between both of introducing port 132, 134 for reversing the core.

The mechanism of this example for controlling main valves 142, 144 via slide bars 146, 148 plays a very important role in the smooth action of the water discharger of this embodiment. More specifically, compressed leaf spring 160, which is stable in the state bent to the right side or the left side, may fall into a metastable, neutral state about halfway between these stable states as shown in FIG. 27(b). That is, in this state, a sufficient biasing force to the left or right does not occur in leaf spring 160. Therefore, in this state, if introducing ports 132, 134 happen to have nearly the same opening, fluid flows in through introducing ports 132, 134 on both sides of the core. Thus the pressure difference vanishes, and the core stops moving. That is, if the timing at which main valves 142, 144 begin to move is earlier than the timing of the reversal of leaf spring 160, the core may stop moving.

In contrast, according to this example, slide bars 146, 148 are provided, and their stroke is appropriately adjusted. Thus, in the metastable neutral state as shown in FIG. 27(b), a state can be maintained where main valves 142, 144 do not yet move while the core continues to move under pressure. Main valves 142, 144 are allowed to begin to move only when leaf spring 160 traverses this neutral state and begins to be reversed. That is, the timing at which main valves 142, 144 begin to move can be synchronized with the timing of the reversal of leaf spring 160.

In other words, before the opening difference enough to move the core is lost, leaf spring 160 is reversed, and main valves 142, 144 are moved by the reversing force (biasing force) via slide bars 146, 148. Thus the opening difference between introducing ports 132, 134 can be inverted to the opening difference enough to move the core in the opposite direction.

This eliminates the problem that introducing ports 132, 134 may have nearly the same opening which results in stopping the core when leaf spring 160 is in the neutral state. Thus a smooth repetitive motion can be achieved.

Furthermore, in this configuration, even when water discharge is started from the state where the core is stopped about halfway through its moving stroke, main valves 142, 144 can be controlled by leaf spring 160 at the beginning of water discharge to be in the state where one of introducing ports 132, 134 is alternatively opened. Thus a pressure difference is produced between both sides of the core, and a stable initial action can be started. That is, the state where the opening of introducing port 134 is larger than the opening of introducing port 132, or the state where the opening of introducing port 132 is larger than the opening of introducing port 134, can be retained alternatively.

As described above, in this embodiment again, the moving direction of the core, the movable direction of main valves 142, 144, the movable direction of slide bars 146, 148, and the biasing direction of leaf spring 160 can be made generally the same to avoid waste in the action of force and to effectively use the moving force of the core having a large pressure-receiving area. Thus a smooth and stable action is achieved. That is, the moving action and the opening control action of the core are interlocked, and thereby the control action to invert the size relation of the opening of introducing ports 132, 134 for the reversal of the core is made reliable and easy. Thus the valve bodies and the control means are made simple and compact.

In the example shown in FIGS. 20 to 27, while slide bar 146, 148 abuts against the inner wall of the housing when the core is reversed, the invention is not limited thereto. For example, slide bars 146, 148 can be provided with a magnet, the inner wall of the housing can also be provided with a magnet, and the repulsive force acting therebetween can be used to stop slide bars 146, 148 relative to the housing. That is, in this case, in the state corresponding to FIGS. 27(a) to 27(c), slide bar 146, 148 does not abut against the inner wall of housing 102, but is located at a prescribed distance apart from the inner wall of housing 102 by the repulsive force of the magnets (not shown). Thus the core can be reversed in a noncontact manner.

Furthermore, in this embodiment, the thrust obtained in the reciprocating linear action is determined by the product of the pressure of fluid loaded on the core and the pressure-receiving area of the core. Therefore, as the pressure-receiving area of the core is increased, a correspondingly larger thrust can be obtained.

While FIGS. 8 to 13 and FIGS. 20 to 26 show an example where a circular core is contained in a generally cylindrical space provided in the housing, the invention is not limited thereto. For example, the interior space of housing main body 102 may be shaped as a rectangular cylinder or a flattened cylinder, and the core may have any of various shapes correspondingly.

The outer peripheral shape of water discharge tubular body 180 does not need to be circular, but may be in a polygonal or flattened shape. Furthermore, water discharge tubular body 180 does not need to be placed at the center of the core, but may be decentered from the center of the core. This facilitates downsizing the core, and the water discharger can be downsized.

When the housing inner space is configured as a cylinder and water discharge tubular body 180 is placed at the center of the cylindrical core as in this example, water discharge tubular body 180 can be rotated. That is, when a water discharge nozzle is provided at the tip water discharge tubular body 180, the reciprocating linear motion of the core allows the water discharge position to be repetitively changed, and at the same time water discharge tubular body 180 can be rotated to change the water discharge direction as well. For example, a cam structure or the like composed of a protrusion and a groove can be provided to rotate the core and the water discharge tubular body about the central axis thereof simultaneously with the movement of the core. In this way, various modes of water discharge depending on the user's preference can be achieved.

FIG. 28 is a schematic cross section showing a variation of the water discharger of this embodiment.

With regard to this figure, elements similar to those described above with reference to FIGS. 1 to 27 are marked with the same reference numerals and not described in detail.

In this variation, water discharge tubular body 180 is provided only on the side of core main body 120. This variation is particularly useful when water discharge is desired only from one end.

Next, a water discharger of the fourth embodiment of the invention is described.

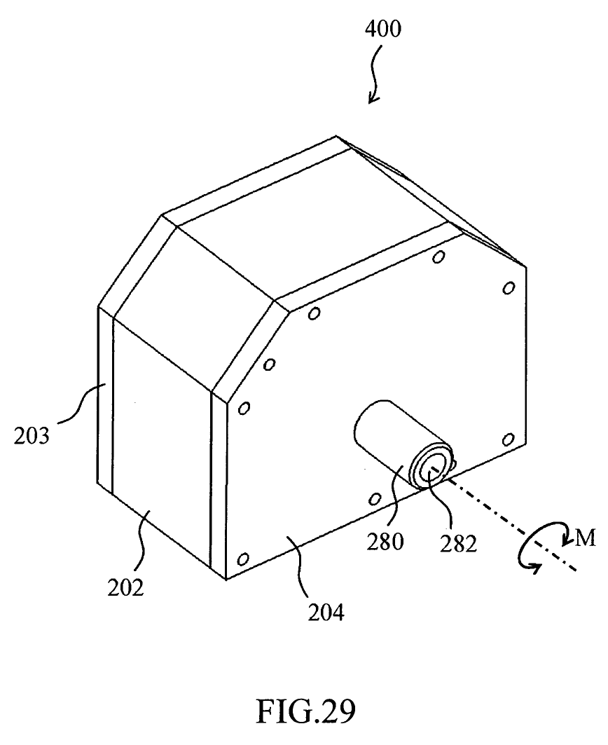

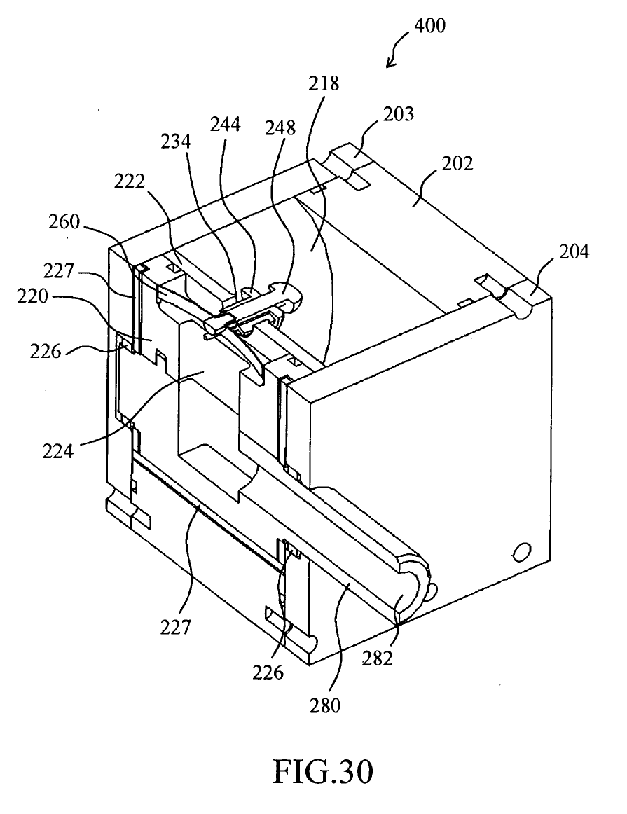

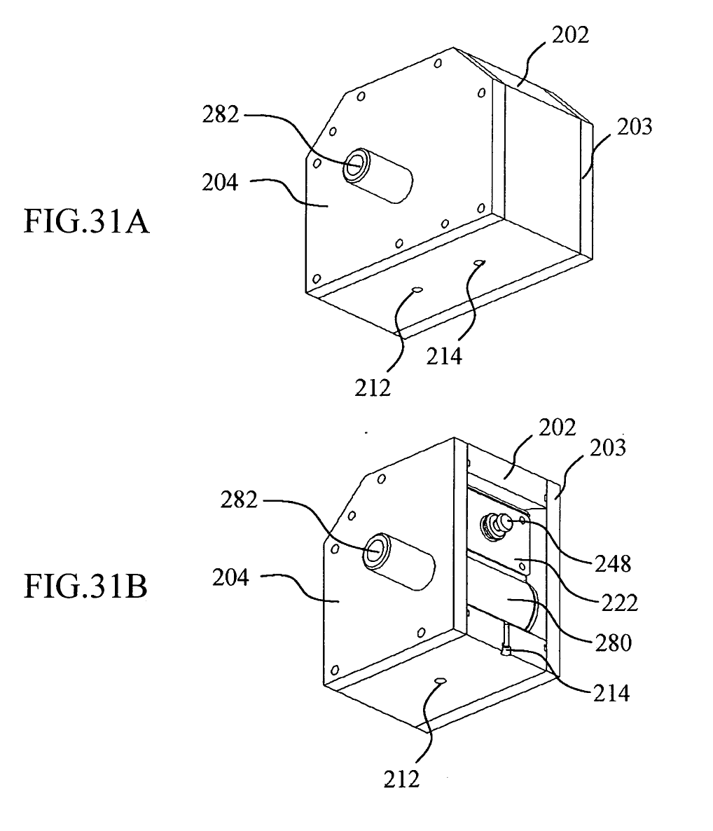

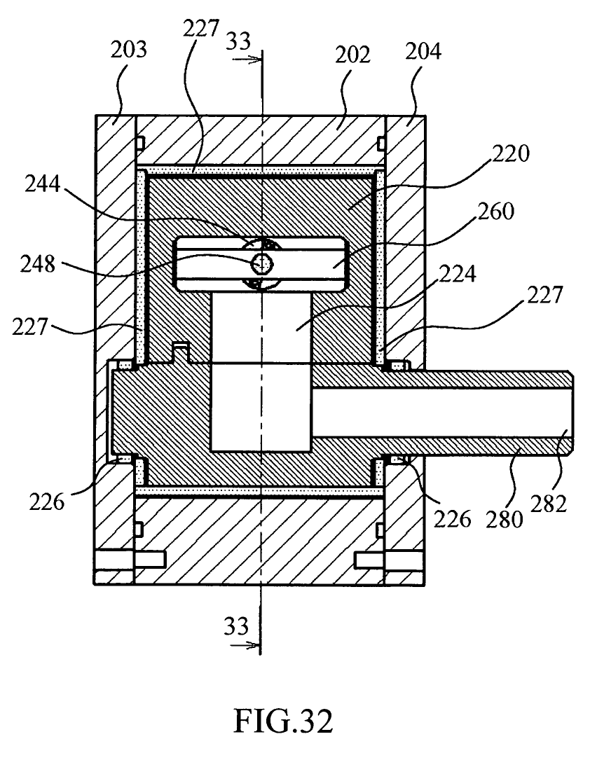

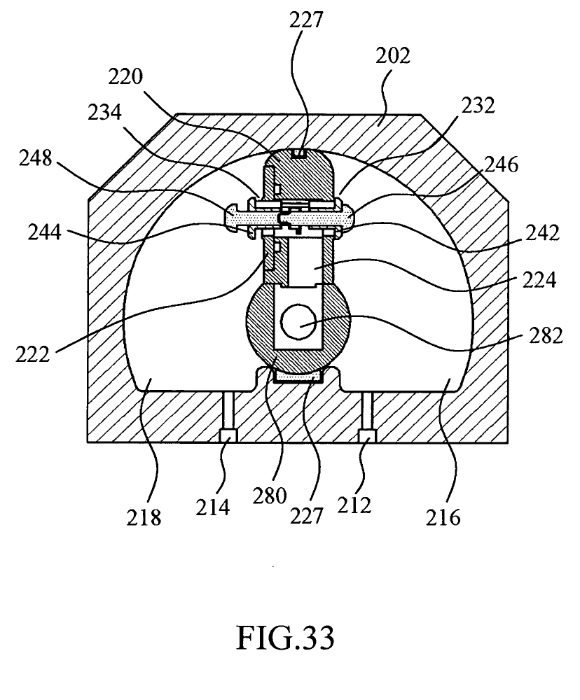

FIGS. 29 to 33 are schematic views showing the relevant part of a water discharger of the fourth embodiment of the invention. More specifically, FIG. 29 is a perspective view of the water discharger of this embodiment, FIG. 30 is a perspective cutaway view thereof, FIG. 31 shows a perspective view and a cutaway view as viewed from the bottom side, FIG. 32 is a vertical cross section, and FIG. 33 is a cross section along line 33-33 in FIG. 32.

Water discharger 400 of this embodiment is similar to the water discharger of the second embodiment described above. Hence elements similar to those described above with reference to FIGS. 15 to 19 are marked with the same reference numerals and not described in detail.

Water discharger 200 of this embodiment also has water discharge tubular body 280 that illustratively protrudes on one side from a housing formed from housing main body 202 and housing lids 203, 204. Water discharge tubular body 280 has a hollow structure having water discharge channel 282 inside and opened at the tip. When fluid such as water is introduced into water inlet ports 212, 214 provided in housing main body 202, water discharge tubular body 280 rotates repetitively in the direction of arrow M.

The internal structure is described. As shown in FIGS. 30 to 33, a core composed of core main body 220 and core lid 222 is contained in a fan-shaped housing space formed from housing main body 202 and housing lids 203, 204, where the core is oscillatable around water discharge tubular body 280.

In this embodiment again, the core has valve bodies and a control means similar to those in the third embodiment. More specifically, core inner channel 224 is formed by combining core lid 222 with core main body 220. Core inner channel 224 communicates with water discharge channel 282 provided in water discharge tubular body 280. Core main body 220 and core lid 222 have introducing ports 232, 234 for allowing core inner channel 224 to communicate with pressure chambers 216, 218. Furthermore, main valves 242, 244 and slide bars 246, 248 are provided so as to traverse core inner channel 224. The shape of the main valve and the slide bar is as described above with reference to FIG. 24. The operation of the valve body and the control means composed of these elements is also similar to that described above with reference to the third embodiment.

That is, as illustrated in FIG. 33, when main valve 244 is moved away from core main body 220, introducing port 234 is opened. Conversely, when main valve 242 is moved away from core main body 220, introducing port 232 is opened.

Introducing ports 232, 234 both communicate with the core inner channel. That is, introducing port 232 allows pressure chamber 216 in the housing to communicate with core inner channel 224, and introducing port 234 allows pressure chamber 218 to communicate with core inner channel 224.

The action of main valves 242, 244 to vary the opening of introducing ports 232, 234 is determined by the coaxially installed slide bars 246, 248. More specifically, as shown in FIGS. 30 and 32, the right and left slide bar 246, 248 are coupled to each other across compressed leaf spring 260, and subjected to a biasing force toward the right end or left end depending on the bend direction of leaf spring 260. Leaf spring 260 is supported at both ends by core main body 220. Slide bars 246, 248 move relatively to core main body 220 via leaf spring 260. Main valves 242, 244 are subjected to the biasing force from slide bars 246, 248 to place introducing ports 232, 234 in one of the state of the fully open state and the fully closed state alternatively.

In the following, the action of water discharger 400 of this embodiment is described.

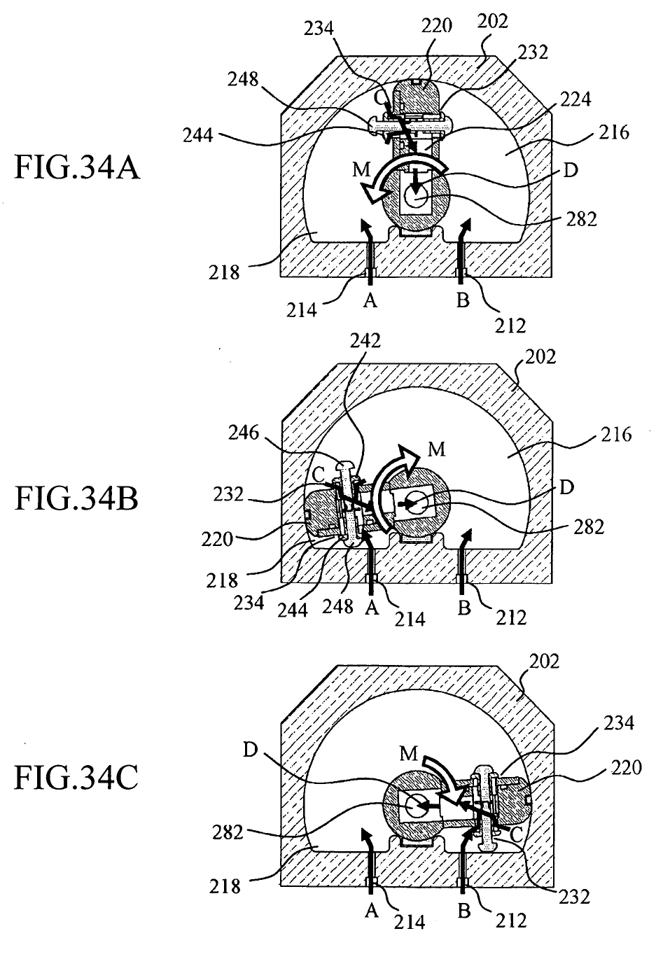

FIG. 34 is a schematic view for describing the action of the water discharger of this embodiment.

First, FIG. 34(a) shows a state where slide bars 246, 248 are biased toward the left side under the action of leaf spring 260. At this time, because main valves 242, 244 are also biased toward the left side by slide bar 246, a state occurs where introducing port 232 is closed and introducing port 234 is opened.

In this state, when fluid such as water is supplied to water inlet ports 212, 214 at nearly the same pressure, the water introduced from water inlet port 214 into pressure chamber 218 as shown by arrow A flows from introducing port 234 into core inner channel 224 as shown by arrow C and flows out as shown by arrow D via water discharge channel 282.

On the other hand, because introducing port 232 is closed, the water introduced from water inlet port 212 into pressure chamber 216 as shown by arrow B has no outflow path and increases the pressure in pressure chamber 216.

That is, by providing an opening difference between introducing ports 232, 234, a difference in channel resistance occurs, which causes a pressure difference. As a result, the pressure becomes higher in pressure chamber 216 than in pressure chamber 218, and the core is pushed and oscillated in the direction of arrow M.

When core main body 220 moves in the direction of arrow M, the volume of pressure chamber 216 increases, and the volume of pressure chamber 218 decreases by that amount. Therefore the fluid in pressure chamber 218 is pushed out by the amount of fluid flowing into pressure chamber 216 via the path of arrow B, and is included in the discharge amount of fluid flowing out of channel 282.

The core further continues to oscillate and slide bar 248 abuts against the inner wall of housing main body 202 and pushed against the core. Then the bend direction of leaf spring 260 is reversed, and slide bars 246, 248 are biased toward the opposite side as shown in FIG. 34(b). Then slide bar 248 pushes main valve 244, and thereby main valves 242, 244 are also moved to the right side (in the clockwise direction). That is, introducing port 232 is opened, and introducing port 234 is closed.

In the state shown in FIG. 34(b), the fluid introduced from water inlet port 212 into pressure chamber 216 as shown by arrow B flows through introducing port 232 into core inner channel 224 as shown by arrow C and flows out via water discharge channel 282 as shown by arrow D. On the other hand, because introducing port 234 is closed, the fluid introduced from water inlet port 214 into pressure chamber 218 as shown by arrow A has no outflow path and increases the pressure in pressure chamber 218. As a result, a pressure difference occurs between pressure chambers 216 and 218, and the core begins to oscillate toward the right side as shown by arrow M.

As shown in FIG. 34(c), the core further oscillates to the position where slide bar 246 abuts against the inner wall of housing main body 202. From this state, the core moves further, and slide bar 246 is pushed against the core to reverse the bend direction of leaf spring 260, which is thus biased to the opposite side. Then, like the state shown in FIG. 34(a), introducing port 232 is closed, introducing port 234 is opened, and the core begins to oscillate toward the left side.

As described above, in this embodiment again, the core is provided with valve bodies composed of main valves 242, 244 and with a control means. Thus the size relation of the opening between the introducing ports can be appropriately inverted depending on the movement of the core to move the core right and left repetitively. In addition, in this embodiment again, as described above with reference to FIG. 27, the timing at which main valves 242, 244 begin reversal action can be synchronized with the timing of the reversal of leaf spring 260. This eliminates the problem that main valves 242, 244 may have nearly the same opening which results in stopping the core when leaf spring 260 is in the neutral state. Thus a smooth repetitive motion can be achieved.

In other words, before the opening difference enough to move the core is lost, leaf spring 260 is reversed, and main valves 242, 244 are moved by the reversing force (biasing force) via slide bars 246, 248. Thus the opening difference between introducing ports 232, 234 can be reversed to the opening difference enough to move the core in the opposite direction.

In this embodiment again, the oscillating direction of the core, the movable direction of main valves 242, 244, the movable direction of slide bars 246, 248, and the biasing direction of leaf spring 260 can be made generally the same to avoid waste in the action of force and to effectively use the moving force of the core having a large pressure-receiving area. Thus a smooth and stable action is achieved. That is, when the core approaches the inner wall of housing main body 202, the moving direction of the core is made generally the same as the movable direction of main valves 242, 244, the biasing direction of leaf spring 260, and the movable direction of slide bars 246, 248. Thus the oscillating action and the opening control action of the core are interlocked, and the action of inverting the size relation of the opening of introducing ports 232, 234 for the reversal of the core is made reliable and easy. Thus the valve bodies and the control means are made simple and compact.

Furthermore, in this configuration, even when water discharge is started from the state where the core is stopped about halfway through its oscillating stroke, main valves 242, 244 can be controlled by leaf spring 260 at the beginning of water discharge to be in the state where one of introducing ports 232, 234 is opened alternatively. Thus a pressure difference is produced between both sides of the core, and a stable initial action can be started. That is, the state where the opening of introducing port 234 is larger than the opening of introducing port 232, or the state where the opening of introducing port 232 is larger than the opening of introducing port 234, can be retained alternatively.

The stroke (oscillating angle) of the oscillating motion of the core in this embodiment can be appropriately configured by the opening angle of the fan-shaped space of housing main body 202. Furthermore, in this embodiment again, the thrust obtained by the oscillating action is determined by the product of the pressure of fluid applied to the core and the pressure-receiving area of the core. Therefore, as the pressure-receiving area of the core is increased, a correspondingly larger thrust can be obtained.

While FIGS. 29 to 34 show an example where water discharge tubular body 280 protrudes only on one side of the housing, the invention is not limited thereto. As with that described above with reference to the first embodiment, water discharge tubular body 280 may protrude on both sides of the housing to provide water discharge from each of water discharge tubular body 280.

In this embodiment, because the core oscillates rather than reciprocates linearly, it is advantageous to adjust the abutment angle between slide bars 246, 248 and the inner wall of housing main body 202.

FIG. 35 is a schematic view for describing the abutment angle between slide bar 246, 248 and the inner wall of housing main body 202 in this embodiment.

More specifically, in this embodiment, because the core oscillates on water discharge tubular body 280, the sliding direction of slide bars 246, 248 varies with the oscillating of the core. Therefore, as shown in FIG. 35(a), if the inner wall surface of housing main body 202 is planar, the sliding direction of slide bars 246, 248 is not always perpendicular to the inner wall surface of housing main body 202. This may cause lateral stress to slide bars 246, 248 and prevent smooth sliding.

In contrast, as shown in FIG. 35(b), by forming the abutment surface of the inner wall of housing main body 202 into a curved concave shape, slide bar 246, 248 can be always in perpendicular abutment in accordance with the oscillating of the core. That is, slide bars 246, 248 can be smoothly slid. Thus the control operation for reversing the core can be made smooth and more reliable.

In this embodiment again, while slide bars 246, 248 abuts against the inner wall of the housing when the core is reversed, the invention is not limited thereto. For example, slide bars 246, 248 can be provided with a magnet, the inner wall of housing main body 202 can also be provided with a magnet, and the repulsive force acting therebetween can be used to stop slide bars 246, 248 relative to the inner wall of housing main body 202. That is, in this case, in the state corresponding to FIG. 35(a) or 35(b), slide bars 246, 248 does not abut against the inner wall of housing main body 202, but is located at a prescribed distance apart from the inner wall of housing main body 202 by the repulsive force of the magnets (not shown). Thus the core can be reversed in a noncontact manner, and slide bars 246, 248 can be smoothly slid irrespective of the shape of the abutment surface of the inner wall of housing main body 202.

The water dischargers of the invention have been described as the first to fourth embodiments of the invention. These water dischargers can be combined with various nozzle parts. In the following, some examples of the water dischargers of the invention will be described.

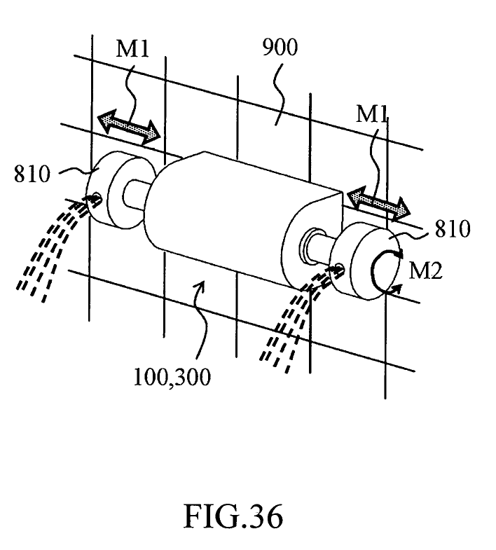

FIG. 36 is a schematic view showing a first example of the water discharger of the invention.

More specifically, in this example, water discharger 100, 300 described above as the first or third embodiment is provided. Water discharge tubular body 180 protrudes on both sides of the housing, and water discharge nozzle 810 is attached to each tip of water discharge tubular body 180. When water discharge tubular body 180 reciprocates linearly in the direction shown by arrow M1, water discharge nozzles 810 also moves repetitively in concert therewith, and the water discharge position is varied periodically. For example, such a water discharger can be installed on wall 900 of a bathroom or the like to pour the discharged water onto the shoulders or the like of a user. Then, because the water discharge position is varied periodically, the massage effect of the so-called “Utaseyu” (hot water falling down on a user's body like a waterfall) can act more extensively and effectively. Furthermore, because the user does not need to swing his/her body for varying the site of action, the usability is improved. Moreover, the discharged water can also be sprayed onto the body extensively to achieve a relaxation effect, and the usability is improved. On the other hand, when water discharge nozzles 810 are fixed, the housing is moved. This motion can be used for massage and the like. That is, the massage effect of “working out of stiffeness” and the like is achieved by pressing one's body against the housing moving right and left.

In addition, in this example, water discharge nozzles 810 can be rotated in the direction of arrow M2 to vary the water discharge direction, as well as the water discharge position, depending on the user's preference.

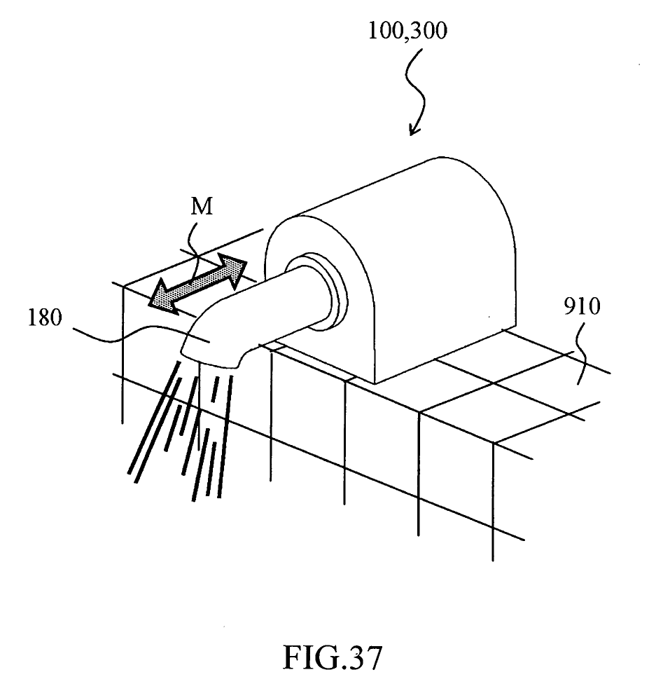

FIG. 37 is a schematic view showing a second example of the water discharger of the invention.

In this example, water discharger 100, 300 described above as the first or third embodiment is provided on base 910. In this water discharger, as described above with reference to FIG. 15, water discharge tubular body 180 protrudes only on one side from the housing and is opened at its tip like a faucet. Water discharge tubular body 180 reciprocates linearly in the direction of arrow M, and the water discharge position is varied periodically. This water discharger can be installed in a scullery, for example, so that the water discharge area can be expanded to improve washing efficiency when a user washes his/her hands or dishes and the like. In this example again, water discharge tubular body 180 can be rotated to vary the water discharge direction, as well as the water discharge position, depending on the user's preference.

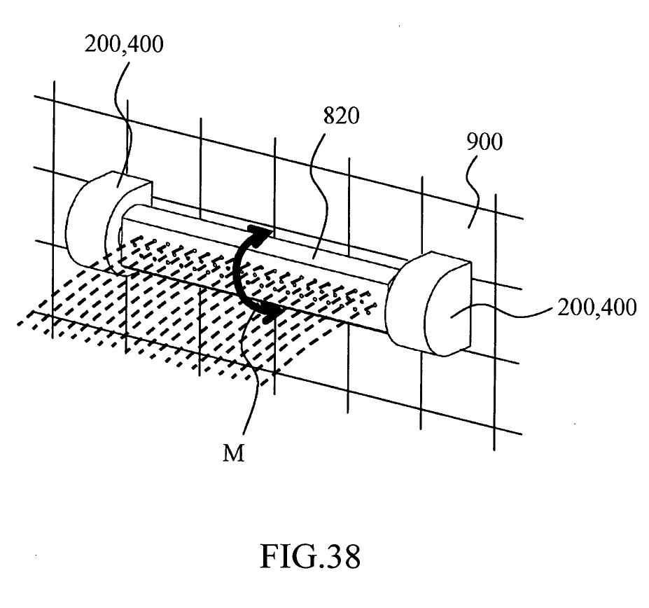

FIG. 38 is a schematic view showing a third example of the water discharger of the invention.

In this example, water discharger 200, 400 described above as the second or fourth embodiment is provided. Water discharger 200, 400 is installed on wall 900, and the water discharge tubular body is equipped with shower nozzle 820. In this example, the driving unit of the water discharger may be provided on both sides of shower nozzle 820. Alternatively, the driving unit may be provided only on one side, and the other side may merely serve as a bearing unit.

In this example, shower nozzle 820 rotates repetitively as shown by arrow M. Thus the discharged water can be extensively sprayed like a shower with a compact configuration. For example, by using this water discharger in a bathroom, the user can take a shower efficiently and conveniently with his/her hands free. A massage effect and a relaxation effect can also be expected from the repetitively varying stimuli of the shower.

On the other hand, when shower nozzle 820 is fixed, the housing of water discharger 200, 400 is rotated. This action can be used for massage and the like. That is, the massage effect of “working out of stiffeness” and the like is achieved by pressing one's body against the housing in repetitive rotation.

This water discharger can be conveniently incorporated in a car washer to apply a shower extensively and uniformly. Furthermore, in various fields of industries including semiconductor, food, health care, paper pulp, and automobile industries, such a water discharger can be incorporated in a washer to efficiently wash various raw materials, ingredients, and parts such as semiconductor wafers and liquid crystal panel substrates. In this case again, various advantageous effects are achieved such as no need to provide power supply, lubricant oil and the like, no generation of electromagnetic noise, no influence of noise, being sanitary, and superior maintainability.

Moreover, the water discharger of this example can also be used for stirring and mixing. For example, by allowing the water discharger of this example sunk in a liquid bath to discharge water while rotating nozzle 820, liquid in the liquid bath can be stirred and mixed. Alternatively, stirring and mixing can also be conducted by fixing nozzle 820 and rotating the housing in the liquid bath.

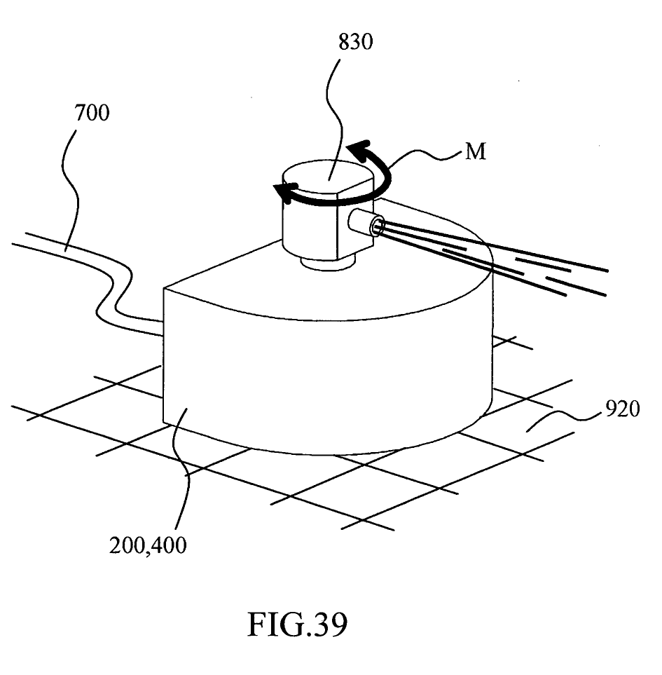

FIG. 39 is a schematic view showing a fourth example of the water discharger of the invention.

In this example, water discharger 200, 400 described above as the second or fourth embodiment is provided on horizontal plane 920, and water discharge tubular body 280 protruding upward is equipped with water discharge nozzle 830 at its tip. When fluid such as water is supplied from water supply piping 700, water discharge nozzle 830 extensively sprinkles water with repetitive rotary motion in the direction of arrow M. This water discharger is suitable for applications such as sprinkling water on plants in gardens, fields and the like, and sprinkling water on playgrounds. That is, a system can be implemented which is small, compact, highly portable, and resistant to external disturbances, and can be operated simply by being coupled to a hose serving as the water supply piping. Thus, a water discharger having a good “retrofittability” can be realized.

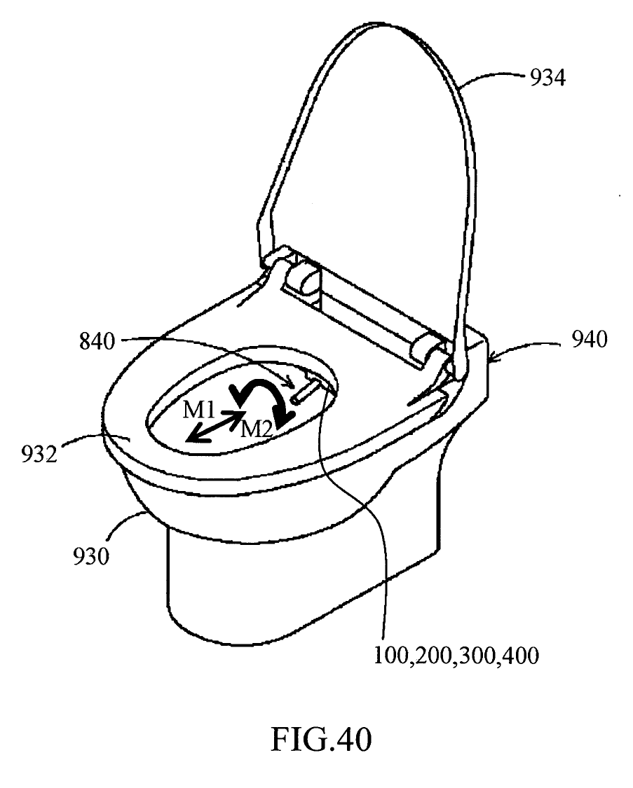

FIG. 40 is a schematic view showing a fifth example of the water discharger of the invention.

In this example, the water discharger of the first to fourth embodiments is incorporated in a body washer of a toilet bowl. More specifically, toilet seat 932 and toilet seat lid 934 are provided on toilet bowl 930, and body washer 940 is provided behind toilet seat 932. Body washer 940 includes any one of the water dischargers described above with reference to the first to fourth embodiments, and the water discharge tubular body thereof is equipped with water discharge nozzle 840.

FIG. 40 shows the body washer in use. When not in use, the water discharge nozzle is retracted behind toilet seat 932. When a user manipulates a prescribed switch, water discharge nozzle 840 extends out as shown and washes the user's buttocks and the like by spraying hot water. At this time, for example, by operating the water discharger of the first or third embodiment, washing can be conducted with water discharge nozzle 840 in reciprocating linear motion as shown by arrow M1. Furthermore, by operating the water discharger of the second or fourth embodiment, washing can be conducted with the water discharge nozzle in repetitive rotary motion as shown by arrow M2. The presence or absence of these reciprocating motions can be switched by providing a plurality of water channels extending to water discharge nozzle 840 and appropriately switching the water channels. When the reciprocating motion is desired, water is passed through the water discharger of the invention and discharged from water discharge nozzle 840. When the reciprocating motion is not needed, water can be switched to bypass the water discharger of the invention and be discharged from water discharge nozzle 840.

According to this example, because water discharge nozzle 840 can be reciprocated simply by hydraulic power, there is no need for motors and the like, and hence no need for electric power. For example, a body washer installed in a toilet bowl in a hotel or the like may be battery driven because a water heating facility is available. In this case, the water discharger of the invention can be used to reciprocate the water discharge nozzle for comfortable and efficient body washing without consuming the limited battery power.

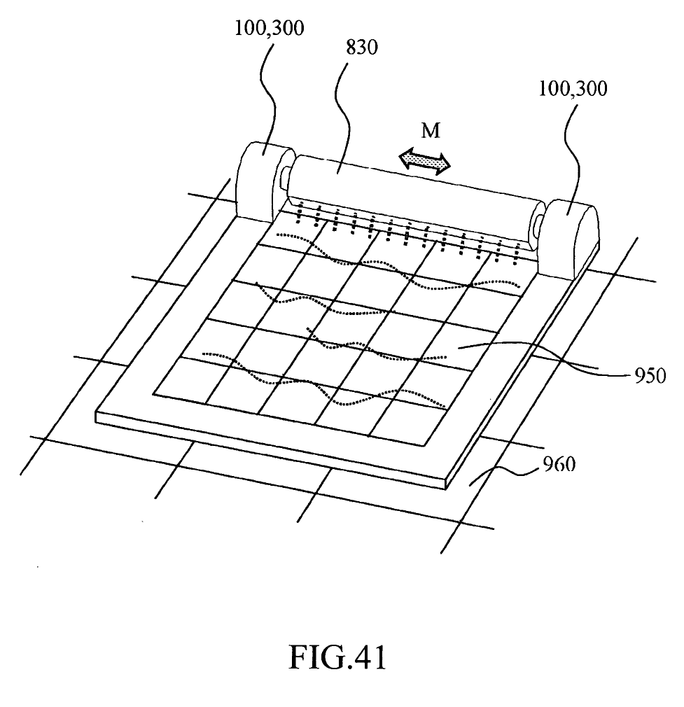

FIG. 41 is a schematic view showing a sixth example of the water discharger of the invention.

In this example, the water discharger of the first or third embodiment is attached to a solar cell panel. More specifically, solar cell panel 950 is installed on roof 960, and water discharger 100, 300 of the invention is installed above solar cell panel 950. Water discharger 100, 300 is equipped with water discharge nozzle 830 having a plurality of water discharge openings arranged on a line, and sprinkles water on the surface of solar cell panel 950 with a reciprocating linear motion in the direction of arrow M.

The surface of solar cell panel 950 needs to be always kept clean for preventing the decrease of the produced electric power. That is, when “stains” due to dust and rainwater or bird excrement and the like are attached, they block sunlight and hence decreases the output electric power.

Furthermore, when the temperature of the solar cell increases, the photoelectric conversion efficiency decreases. Therefore it is desirable to uniformly cool down the solar cell panel. Here, from the viewpoint of effectively using heat of vaporization and from the viewpoint of resource saving, water discharge needs to be conducted uniformly and extensively with the smallest possible amount of water. In this respect, according to this example, the reciprocating linear motion of the water discharge nozzle having a plurality of water discharge openings arranged on a line allows water to be discharged uniformly and extensively on the surface of solar cell panel 950 with a small amount of water. As a result, a good washing effect and a uniform cooling effect are achieved, which can always maintain the output of the solar cell panel in the best condition.

In this example, when the stroke of reciprocating linear motion is made comparable to or more than the pitch of the water discharge openings of water discharge nozzle 830, water can be discharged uniformly on the surface of solar cell panel 950. Furthermore, in this example again, the driving unit may be provided on both sides of water discharge nozzle 830. Alternatively, the driving unit may be provided only on one side, and the other side may merely serve as a bearing unit.

Besides the solar cell panel, the water discharger in this example is also suitable for use in washing or cooling, for example, the roofs or walls of buildings, houses and the like. That is, uniform water discharge on a prescribed area with a small amount of water achieves a good washing or cooling effect, which, for example, can efficiently prevent the “heat island phenomenon” and the like.

Embodiments of the invention have been described with reference to examples. However, the invention is not limited to these examples.

That is, even if any of the elements constituting the water discharger of the invention is modified by those skilled in the art, it is encompassed within the scope of the invention if it includes the spirit of the invention.

For example, with regard to the water inlet ports, they only need to be provided corresponding to the right and left pressure chamber, respectively. For example, the number of water inlet connection ports from outside to the housing can be reduced to one by providing channels branched in the housing and coupling these channels to the water inlet ports of both sides of the pressure chamber, respectively. That is, water supplied from outside via the water inlet connection port of the housing is supplied via the branched channels in the housing to the respective pressure chambers. Thus the piping to the housing can be simplified.

Furthermore, for example, even if the outline of the driving unit and the water discharge nozzle of the water discharger, the shape or placement of the constituent parts, the stroke and rotation angle, and the like are appropriately modified by those skilled in the art, they are encompassed within the scope of the invention as long as they include the spirit of the invention.

### INDUSTRIAL APPLICABILITY

As described above, the invention can provide a water discharger having a compact and simple structure and capable of repetitive linear action or rotary action using hydraulic power, achieving significant industrial advantages.

1. A water discharger comprising:
a housing having a columnar space inside;
a core having a core inner channel inside allowed to move in the columnar space while dividing the columnar space into a first and a second pressure chamber;
a water discharge tubular body having a water discharge channel communicating with the core inner channel and reaching the outside of the housing;
a first water inlet port configured to introduce fluid to the first pressure chamber;
a second water inlet port configured to introduce fluid to the second pressure chamber;
a first introducing port configured to introduce fluid from the first pressure chamber to the core inner channel;
a second introducing port configured to introduce fluid from the second pressure chamber to the core inner channel;
a valve body configured to change the opening of the first and the second introducing ports; and
a control mechanism configured to invert the size relation of the opening of the first and the second introducing ports when the core reverses its moving direction.

2. A water discharger according to claim 1, wherein
the core moves toward the second pressure chamber when fluid is supplied to the first and second water inlet ports with the first introducing port being closed and the second introducing port being opened, and
the core moves toward the first pressure chamber when fluid is supplied to the first and second water inlet ports with the second introducing port being closed and the first introducing port being opened.

3. A water discharger according to claim 1, wherein the moving direction of the core is the same as the movable direction of the valve body.

4. A water discharger comprising:
a housing having a fan-shaped space inside;
a core having a core inner channel inside allowed to oscillate in the space while dividing the fan-shaped space into a first and a second pressure chamber;
a water discharge tubular body having a water discharge channel communicating with the core inner channel and reaching the outside of the housing;
a first water inlet port configured to introduce fluid to the first pressure chamber;
a second water inlet port configured to introduce fluid to the second pressure chamber;
a first introducing port configured to introduce fluid from the first pressure chamber to the core inner channel;
a second introducing port configured to introduce fluid from the second pressure chamber to the core inner channel;
a valve body configured to change the opening of the first and the second introducing ports; and
a control mechanism configured to invert the size relation of the opening of the first and the second introducing ports when the core reverses its oscillating direction.

5. A water discharger according to claim 4, wherein
the core oscillates toward the second pressure chamber when fluid is supplied to the first and second water inlet ports with the first introducing port being closed and the second introducing port being opened, and
the core oscillates toward the first pressure chamber when fluid is supplied to the first and second water inlet ports with the second introducing port being closed and the first introducing port being opened.

6. A water discharger according to claim 4, wherein the oscillating direction of the core is the same as the movable direction of the valve body.

7. A water discharger according to claim 4, wherein, when the core reverses its oscillating direction, at least one of the valve body and the control means mechanism abut against an inner wall of the housing, and an abutment of the inner wall maintains a generally perpendicular relation to the movable direction of the valve body.

8-11. (canceled)

12. A water discharger according to claim 1, wherein the control mechanism includes a spring.

13. A water discharger according to claim 1, wherein the control mechanism includes a magnet.

14. A water discharger according to claim 4, wherein the control mechanism includes a spring.

15. A water discharger according to claim 4, wherein the control mechanism includes a magnet.

16. A water discharger comprising:
a housing having a columnar space inside;
a core having a core inner channel inside allowed to move in the columnar space while dividing the columnar space into a first and a second pressure chamber;
a water discharge tubular body having a water discharge channel communicating with the core inner channel and reaching the outside of the housing;
a first water inlet port configured to introduce fluid to the first pressure chamber;
a second water inlet port configured to introduce fluid to the second pressure chamber;
a first introducing port configured to introduce fluid from the first pressure chamber to the core inner channel;
a second introducing port configured to introduce fluid from the second pressure chamber to the core inner channel;
a valve body configured to change the opening of the first and the second introducing ports; and
a control mechanism configured to change a ratio of the opening of the first and the second introducing ports when the core reverses its moving direction.

17. A water discharger according to claim 16, wherein
the core moves toward the second pressure chamber when fluid is supplied to the first and second water inlet ports with the first introducing port being closed and the second introducing port being opened, and
the core moves toward the first pressure chamber when fluid is supplied to the first and second water inlet ports with the second introducing port being closed and the first introducing port being opened.

18. A water discharger according to claim 16, wherein the moving direction of the core is the same as the movable direction of the valve body.

19. A water discharger according to claim 16, wherein the control mechanism includes a spring.

20. A water discharger according to claim 16, wherein the control mechanism includes a magnet.

21. A water discharger comprising:
a housing having a fan-shaped space inside;
a core having a core inner channel inside allowed to oscillate in the fan-shaped space while dividing the fan-shaped space into a first and a second pressure chamber;
a water discharge tubular body having a water discharge channel communicating with the core inner channel and reaching the outside of the housing;
a first water inlet port configured to introduce fluid to the first pressure chamber;
a second water inlet port configured to introduce fluid to the second pressure chamber;
a first introducing port configured to introduce fluid from the first pressure chamber to the core inner channel;
a second introducing port configured to introduce fluid from the second pressure chamber to the core inner channel;
a valve body configured to change the opening of the first and the second introducing ports; and
a control mechanism configured to change a ratio of the opening of the first and the second introducing ports when the core reverses its oscillating direction.

22. A water discharger according to claim 21, wherein
the core oscillates toward the second pressure chamber when fluid is supplied to the first and second water inlet ports with the first introducing port being closed and the second introducing port being opened, and
the core oscillates toward the first pressure chamber when fluid is supplied to the first and second water inlet ports with the second introducing port being closed and the first introducing port being opened.

23. A water discharger according to claim 16, wherein the oscillating direction of the core is the same as the movable direction of the valve body.

24. A water discharger according to claim 21, wherein, when the core reverses its oscillating direction, at least one of the valve body and the control mechanism abut against an inner wall of the housing, and an abutment of the inner wall maintains a generally perpendicular relation to the movable direction of the valve body.

25. A water discharger according to claim 21, wherein the control mechanism includes a spring.

26. A water discharger according to claim 21, wherein the control mechanism includes a magnet.
